(19) United States
(12) Patent Application Publication
(10) Pub. No.: US 2025/0051129 A1
(43) Pub. Date: Feb. 13, 2025

(54) MULTIPHASE TRACTION ELEVATOR CONTROLLER AND METHOD OF USE

(71) Applicant: Smartrise Engineering, Inc., Irving, TX (US)

(72) Inventors: Gilbert Zogbi, Irving, TX (US); Keith Soneda, Oakland, CA (US)

(73) Assignee: Smartrise Engineering, Inc., Irving, TX (US)

(21) Appl. No.: 18/798,251

(22) Filed: Aug. 8, 2024

Related U.S. Application Data
(60) Provisional application No. 63/518,245, filed on Aug. 8, 2023.

(51) Int. Cl. B66B 1/28; B66B 1/30; B66B 1/34; B66B 5/00

(52) U.S. Cl. CPC B66B 1/285; B66B 1/30; B66B 1/3492; B66B 5/0018

(57) ABSTRACT

The present invention pertains to an advanced traction control system designed to enhance the performance of traction elevators. This system integrates multiple components and a novel S-curve algorithm to optimize acceleration and deceleration profiles, ensuring smooth transitions and improved ride quality. Key components include a central controller, motor room board, hall panel controllers, and a car panel controller. The system supports high-speed applications, accommodating speeds up to 1400 feet per minute. The S-curve routine is divided into acceleration, constant speed, and deceleration phases, with digital speed commands transmitted via a serial communication link to the motor drive every 10 milliseconds. This precise control reduces mechanical wear and enhances passenger comfort. The system can adapt to various speed profiles, including normal, short, inspection, and emergency power modes, ensuring optimal performance under different conditions. This invention significantly improves the efficiency, safety, and durability of traction elevator systems.

### CROSS-REFERENCE TO RELATED APPLICATIONS

This application claims priority benefit from U.S. Provisional Application No. 63/518,245, filed on Aug. 8, 2023. The patent application identified above is incorporated here by reference in its entirety to provide continuity of disclosure.

### FIELD OF THE INVENTION

The present invention relates to elevator control systems, specifically those employing advanced algorithms to enhance the ride quality, efficiency, and durability of traction elevator systems. This invention addresses the need for smoother acceleration and deceleration profiles to improve passenger comfort and reduce mechanical wear, in a number of specialized situations.

### BACKGROUND OF THE INVENTION

Traction elevator systems represent a sophisticated segment of vertical transportation technology, leveraging advanced control mechanisms to deliver efficient and smooth travel between floors. These systems typically utilize a counterweight, ropes, and a motor-driven traction sheave to move the elevator car.

Traction elevators offer several advantages over other types of elevator systems, such as hydraulic elevators, including energy efficiency, speed, and capacity. They generally consume less power, particularly in high-rise buildings where counterweighting can significantly reduce the energy required to move the elevator car. They are capable of higher speeds and greater travel distances, making them suitable for tall buildings.

Over recent decades, advancements in control technologies, such as variable voltage, variable frequency drives, and digital speed pattern generators, have significantly enhanced the performance and reliability of traction elevators. Modern elevator systems, particularly those employing traction drive mechanisms, now rely heavily on sophisticated control algorithms to manage acceleration and deceleration.

U.S. Pat. No. 4,155,426 to Booker, Jr. and U.S. Pat. No. 5,035,301 to Skalski, illustrate the evolution of control systems from basic mechanical methods to highly sophisticated digital control techniques.

Despite these advances, modern elevator control systems still face several challenges, particularly related to the smoothness of the ride and the durability of the mechanical components. For example, traditional control systems often produce high jerk values, leading to a jarring experience for passengers and increased wear on mechanical components. The mechanical stress resulting from inefficient speed control can lead to accelerated wear and tear on critical components, such as the motor, brakes, and traction sheave. This not only reduces the lifespan of the equipment but also increases maintenance costs and downtime. Achieving accurate stopping and positioning is crucial for passenger safety and system reliability. Traditional systems also struggle with precise control during emergency and inspection situations, leading to floor leveling inaccuracies and potential safety hazards.

There have been many attempts in the prior art to address these problems using various control techniques. For example, patents such as U.S. Pat. No. 4,553,640 to Inaba, et al. and European Patent No. EP2602221B1 to Konig, address the problems associated with rough rides caused by abrupt changes in acceleration and deceleration.

U.S. Pat. No. 4,155,426 Booker, Jr. discloses an elevator control system employing a variable voltage, variable frequency approach to maintain consistent speed under varying load conditions. The system generates a first digital speed pattern signal from a pulse train with a constant average pulse rate and a second digital speed pattern signal during deceleration, responsive to the elevator's distance from the desired stopping point. The speed pattern signal adjusts between zero and a predetermined maximum value within predefined jerk and acceleration constraints.

U.S. Pat. No. 6,202,796 to Lee, discloses a method for controlling an elevator car's position by generating a velocity command signal to follow a velocity pattern. The elevator system features an encoder that provides pulse signals corresponding to the motor's rotation and a way to calculate the distance traveled by the elevator car based on the encoder's pulse signals.

European Patent No. EP2602221B1 to Konig discloses a method for controlling the movement of a load, such as an elevator, via a computer-readable medium with executable instructions. The load, connected to a drive controlled by a controller, follows a predetermined movement routine with a nominal speed and a creep speed. The controller issues a deceleration command to the drive when the load's current position and the creep position distance equals the acceleration and deceleration distances.

U.S. Pat. No. 4,553,640 to Inaba, et al., discloses an elevator controller that includes a peripheral interface adaptor for interfacing the CPU with external digital signals, a programmable timer module for detecting acceleration and velocity by counting pulses from a rotary encoder, a bus for address and data transfer, a digital-to-analog converter, and an analog-to-digital converter. The controller features a rotary encoder for generating pulses based on car travel distance. The system generates acceleration commands for the elevator car and directly controls the motor. The acceleration command generation comprises a gradually increasing acceleration start mode, a constant acceleration mode, and a gradually decreasing acceleration reduction mode. Transitions between these modes are based on specified conditions, such as the car's acceleration reaching a specified value and the actual velocity approaching the desired velocity.

U.S. Pat. No. 5,035,301 to Skalski, discloses an elevator speed dictation system that controls the acceleration and deceleration of an elevator. The system uses a table to store acceleration, velocity, and position values. Upon issuing a stop control command, the system employs a distance error calculation based on the dictated position and the actual distance traveled.

Advancements in traction elevator control systems have significantly improved the efficiency, safety, and comfort of vertical transportation. However, prior art systems still face challenges related to accurately controlling elevator motion during varied operating conditions. The innovations described in this disclosure provide sophisticated solutions to these problems through advanced digital control techniques and optimized acceleration and deceleration profiles.

### SUMMARY OF THE INVENTION

The present invention pertains to a traction control system which integrates multiple components and a novel “S-curve” algorithm to ensure smooth operation of traction elevators. This system is designed to accommodate high-speed and high-rise applications, supporting speeds up to 1400 feet per minute.

The preferred components of the traction control system include the central controller, the motor room board, a number of hall panel controllers and a car panel controller.

The central controller functions to receive commands and sensor inputs to move the elevator car between the start position and its destination. To do so, the central controller employs software to guide the elevator car through several phases, depending on various constraints imposed on the car during the trip, based on various sets of conditions.

An important feature of the traction control system is the S-curve routine, designed to optimize the elevator's acceleration and deceleration profiles. The routine ensures smooth transitions between different “speed phases.” The speed phases include into three main phases: acceleration, constant speed, and deceleration. During the acceleration phase, the elevator transitions from zero to cruising speed with a positive jerk, leading to a parabolic increase in velocity. The constant speed phase maintains a stable cruising speed, while the deceleration phase involves a negative jerk, smoothly bringing the elevator to a stop after the leveling distance.

Speed commands are generated digitally and transmitted via a serial communication link to the motor drive, ensuring precise control over the speed profile of the elevator car. Serial messages are relayed to the drive about every 10 milliseconds, utilizing an RS-485 physical communication interface. Various parameters of the routine can be adjusted to fine-tune the motion profile. This digital communication ensures the accuracy of the speed commands and their timely execution.

In general, the S-curve routine involves computing the instantaneous motor command speed while the system is in motion, which is then relayed to the motor drive. Computing the speed command is done by the central controller which actively generates and modifies the S-curve for each speed profile and sends it to the drive.

The system accommodates four speed profiles, each designed for different applications and scenarios. Each profile features a unique set of adjustable parameters shaping the S-curve, as will be further described.

The “normal profile” is utilized under standard operating conditions and adhered to when the distance permits a cruising phase (constant speed phase). This cruising speed is also known as the contract speed which is usually an adjustable parameter dictated by the elevator mechanics.

When the distance is shorter than a predefined threshold, a “short profile” is implemented, with modified parameters to suit the lower cruising speed. The maximum speed possible is automatically computed by the central controller based on the original contract speed and the short profile parameters.

The “inspection profile” is activated when the elevator is in inspection or manual mode. Since such modes are usually used for inspection or maintenance purposes, lower speeds are typically desired. Additional parameters are used to set the inspection speed which the central controller uses as the cruising speed for the inspection profile.

The “emergency power profile” is used when the elevator operates on emergency or standby power, where speeds and accelerations are determined by the available power. In this mode, a cruising speed lower than the contract speed is usually desired. This speed is set by another parameter. Prior to each run, the central controller evaluates its forthcoming destination and the current mode to select the most appropriate speed profile.

The control routine uses the parameters of the selected speed profile to compute the properties of “inflection points” of velocity, position, and time, to serve as reference points for the impending run. These inflection points, in conjunction with the starting and destination points, outline the different phases of the S-curve as they mark the positions where a regime change is necessary. As the system operates, the current position is cross-referenced with the position values of the key points in memory. This allows the central controller to calculate the instantaneous command speed in real-time based on the current phase of the S-curve.

### BRIEF DESCRIPTION OF THE DRAWINGS

In the detailed description of the preferred embodiments presented below, reference is made to the accompanying drawings.

FIG. 1 is a schematic illustration of a preferred traction elevator system.

FIG. 2 is an architecture drawing of a preferred traction elevator control system.

FIG. 3A is an exemplary graph of elevator car position versus time.

FIG. 3B is an exemplary graph of elevator car velocity versus time.

FIG. 3C is an exemplary graph of elevator car acceleration versus time.

FIG. 3D is an exemplary graph of elevator jerk versus time

FIG. 4 is a flow chart of a control routine for a preferred system.

FIG. 5 is a flow chart of an automatic operation routine for a preferred system.

FIG. 6A is a flow chart of a calculate maximum possible speed of run distance routine for a preferred system.

FIG. 6B is a flow chart of a S-curve calculation routine for a preferred system.

FIGS. 7A, 7B and 7C is a flow chart of an acceleration phase routine for a preferred system.

FIGS. 8A, 8B and 8C is a flow chart of a cruising phase routine for a preferred system.

FIGS. 9A, 9B and 9C is a flow chart of a deceleration phase routine for a preferred system.

FIG. 10 is a flow chart of an emergency power acceleration routine for a preferred system.

FIGS. 11A and 11B is a flow chart of an emergency power deceleration routine for a preferred system.

FIGS. 12A and 12B is a flow chart of an inspection acceleration routine for a preferred system.

FIG. 13 is a flow chart of an inspection cruising deceleration routine for a preferred system.

### DETAILED DESCRIPTION OF THE INVENTION

In the description that follows, like parts are marked throughout the specification and figures for the same numerals. The figures are not necessarily drawn to scale and may be shown in exaggerated or generalized form in the interest of clarity and conciseness. Unless otherwise noted, all tolerances and uses of the term “about” indicate plus or minus 20%.

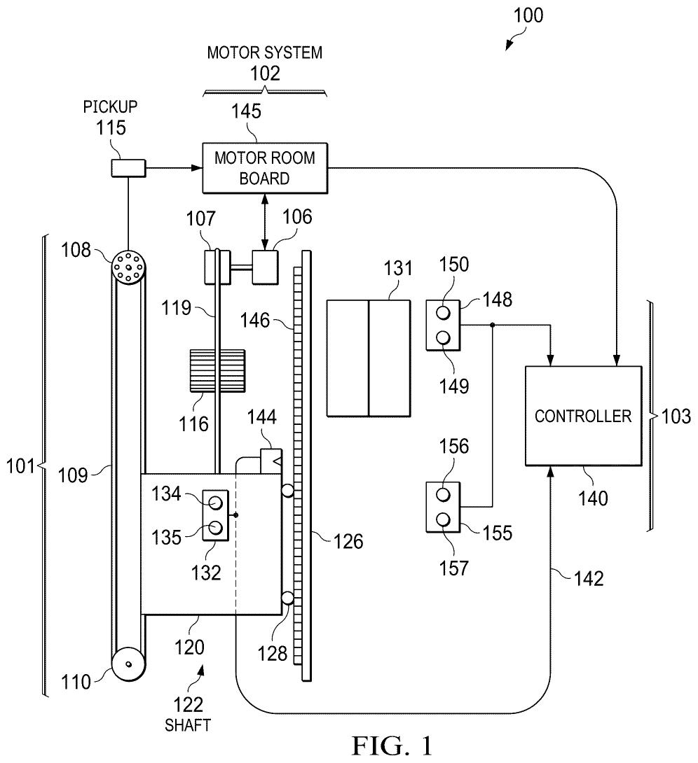

Referring to FIG. 1, preferred traction elevator system 100 will be further described.

Elevator system 100 includes mechanical system 101, motor system 102 and control system 103.

Mechanical system 101 includes elevator car 120 movably disposed within shaft 122. Shaft 122 is made up of a plurality of rails, such as rail 126. Elevator car 120 is guided up and down shaft 122, along rails 126 by a plurality of guide wheels, such as guide wheels 128. Mechanical doors, such as doors 131 are positioned adjacent shaft 122 at each floor level.

Motor system 102 includes drive motor 106, may either be a geared traction motor or a gearless traction motor. The drive motor 106 can also be either a DC or AC current motor. Drive motor 106 is mechanically coupled to traction sheave 107 mounted on the shaft of drive motor 106. Elevator car 120 is supported by hoist rope 119 which is reaved over traction sheave 107. Counterweight 116 is connected to hoist rope 119. Counterweight 116 offsets the weight of elevator car 120 and approximately half of its rated load and provides mechanical efficiency and operating smoothness to the system. When drive motor 106 is activated, it rotates traction sheave 107 thereby moving hoist rope 119, elevator car 120 and counterweight 116.

Governor rope 109 is also connected to elevator car 120 and is reaved over governor sheave 108, located at the highest point of travel of the car in shaft 122. Governor rope 109 is also reaved over pulley 110, located at the bottom of the elevator shaft. Pickup 115 is operably disposed adjacent governor sheave 108 to detect movement of the governor sheave, and hence elevator car 120 through optical or magnetic means, as is known in the art.

Control system 103 includes controller 140, car panel controller 132, control panels 148 and 155, sensor 144, motor room board 145, and pickup 115.

Controller 140 functions to receive command signals from the car panel controller and control panels and data from the various sensors and then to calculate motor commands based on profiles stored in memory, as will be further described.

Car panel controller 132 includes control buttons 134 and 135 and circuitry used to open and close the car doors. Control buttons 134 and 135 are used to instruct the car as to the destination and direction of travel. Car panel controller 132 is operatively connected to controller 140 through umbilical cord 142.

Control panels 148 and 155 are fixed externally to shaft 122. Control panel 148 includes up button 150 and down button 149. Likewise control panel 155 includes up button 156 and down button 157. Both control panel 148 and control panel 155 are operatively connected to controller 140. The control panels send “call” signals to the controller, as will be further described.

Sensor 144 is operatively connected to car panel controller 132, adjacent tape 146. Preferably, the sensor is an optical sensor. Tape 146 is originally fixed longitudinally inside shaft 122 and includes a printed code or gradations that indicate vertical position in the shaft. In use, sensor 144 records elevator velocity and position by constantly examining tape 146, and sending data back to controller 140, as is known in the art.

Motor room board 145 is operatively connected to controller 140. The motor room board acts as an interface to the controller and is responsible for the exchange of serial data between pickup 115 and drive motor 106 and generally managing communication and control signals throughout the system.

In operation, a passenger request signal for moving elevator car 120 in the up or down directions, to a specific destination, is received at car panel controller 132 or control panels 148 or 155. The request signal is sent to controller 140. Upon receipt of the signal, controller 140 conducts a number of calculations, and generates the appropriate signals to the motor room board, which activates the motor to control movement of elevator car 120, as will be further described.

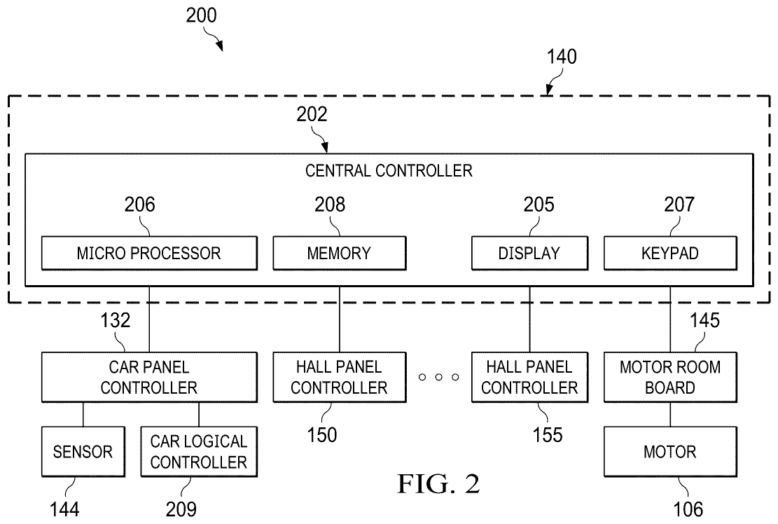

Referring to FIG. 2, a schematic overview of control system 200 will be further described.

Controller 140 includes microprocessor 206 operatively connected to memory 208. Memory 208 includes instructions, that when executed by microprocessor 206 cause the system to function, as will be further described. The controller further includes display 205 and keypad 207, both operatively connected to the microprocessor. The keypad is used to provide instructions and data to the microprocessor. The display is used for the microprocessor to indicate the current status of the system and show the values of various operational parameters of the system. Preferably, controller 140 is the MR Board Model No. SR3032, available from Smartrise Engineering, Inc. of Irving, Texas.

Controller 140 is operatively connected to motor room board 145. Motor room board 145 is further operatively connected to drive motor 106. Motor room board 145 functions as the primary interface to the controller responsible for the exchange of serial data between the motor, brakes, safety equipment, the hall panel controllers and the car panel controller. It plays a pivotal role in managing communication and control signals throughout the system. The motor room board also includes various settings that configure functionalities such as CPU stop, learn mode, and motor tune processes, ensuring safety checks are completed before enabling the motor contactor.

Motor room board 145 receives command signals from controller 140 and is responsible for activating and deactivating drive motor 106 which results in raising and lowering elevator car 120. Preferably, motor room board 145 is the Smartrise Universal Board Model No. SR 3030, available from Smartrise Engineering, Inc. of Irving, Texas.

Controller 140 is further operatively connected to a number of hall panel controllers, such as hall control panels 148 and 155. In one embodiment, controller 140 supports up to 32 hall control panels. The hall control panels receive signals from hall call buttons and transmits them directly to the central controller, as will be further described. Preferably, the hall panel controllers are each a hall board Model No. SR 1060, available from Smartrise Engineering, Inc.

Controller 140 is further connected to car panel controller 132. Car panel controller 132 receives signals from call buttons and other safety mechanisms and passes them directly to controller 140. Car panel controller 132 is operatively connected to sensor 144. The car panel controller receives signals from sensor 144 related to the car's position and velocity, and passes them directly to controller 140, as will be further described.

Car panel controller 132 is further connected to car logic controller 209. Car logic controller 209 generates and sends control signals which regulate opening and closing the car doors (not shown). Car logic controller 209 is preferably the CLC Board available from Smartrise Engineering, Inc. of Irving, Texas.

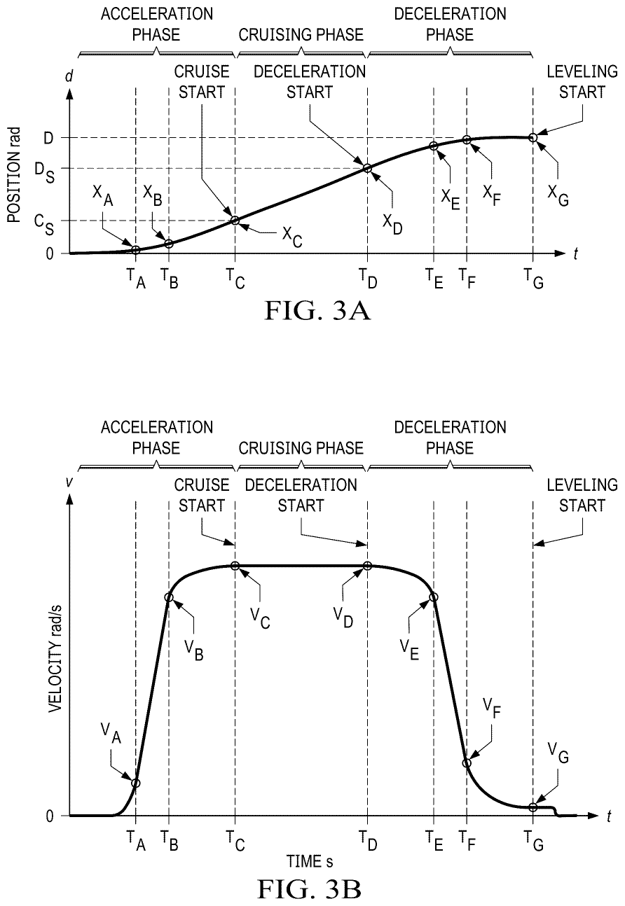

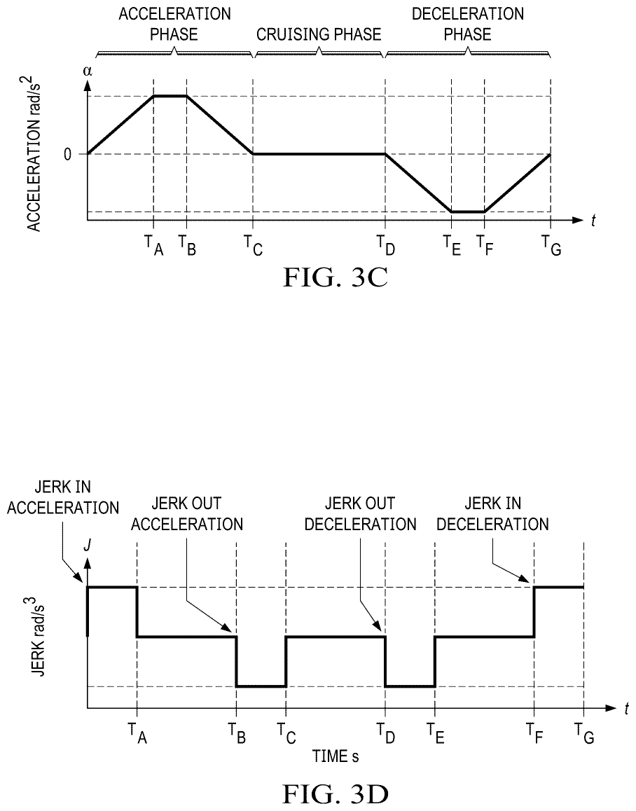

Referring to FIGS. 3A, 3B, 3C and 3D, relevant motion curves will be further described. Each curve is divided into three phases. The first phase is the acceleration phase, during which the speed escalates from zero to the cruising (or maximum) speed. The second phase maintains a constant speed with zero acceleration. The third phase is the deceleration phase, during which the speed decreases from the cruising speed to zero, after a leveling period.

The phases may be demarcated by a series of time inflection points, velocity inflection points, and position inflection points. At T₀, the car is at rest and the start velocity, V₀, is zero. The position, Xₐ, is the start position. At time, Tₐ, the elevator car has reached velocity, Vₐ, and position, Xₐ. This is also the point where constant acceleration begins. When constant acceleration stops, the elevator car has reached velocity, V_{b} and position, X_{b}, at time, T_{b}. The elevator car stops accelerating at time, T_{c}, at which it has reached position, X_{c}, and velocity, V_{c}. This is also known as the cruise start position. At time, T_{d}, the elevator ends its cruising phase and begins decelerating at velocity, V_{d}, and position, X_{d}. In a preferred embodiment, the velocity, V_{c}, and V_{d}, are equal.

At time, Tₑ, the elevator car begins constant deceleration at position, Xₑ, and at velocity, Vₑ. At time, T_{f}, the elevator car ends constant deceleration at position, X_{f}, and velocity, V_{f}. The elevator car begins leveling at position, X_{g}, at time, T_{g}, and at velocity, V_{g}.

For acceleration, the first phase involves a constant positive jerk, resulting in a linear increase in acceleration and hence a parabolic growth in velocity. When acceleration is constant and jerk is zero, speed increases linearly until jerk takes on a constant negative value. This results in a linear decrease in acceleration and, consequently, a parabolic decay in velocity. The dynamics of the deceleration phase mirror those of the acceleration phase, though jerk and acceleration values can vary significantly between phases.

Although the deceleration curve is generally symmetric in shape to the acceleration curve, S-curve, the speed during deceleration is reduced to a minimum value which is referred to as the “leveling speed.” The elevator moves at that speed before eventually stopping when it reaches the destination position. The leveling speed and the distance at which the leveling speed is commanded (known as the “leveling distance”) are both predefined and adjustable parameters.

In operation, the elevator car accelerates from zero velocity to a constant high speed over an acceleration time. The car maintains this constant high speed for a finite time, until it reaches the slow-down position or “transition position.” The constant high speed should always be below the maximum speed of the elevator set during installation known as the “contract speed.” Upon reaching the transition position, the elevator car begins to decelerate from the constant high speed, through the deceleration time, toward the constant leveling speed. The elevator car moves through a transition distance when its velocity is between the constant high speed and the constant leveling speed during the transition time. After the transition distance, the elevator car reaches a constant leveling speed, and stays at this constant leveling speed, throughout the leveling distance, during the leveling time. After the leveling time, the car comes to a complete stop at the destination. The transition distance plus the leveling distance is known as the “slowdown distance.”

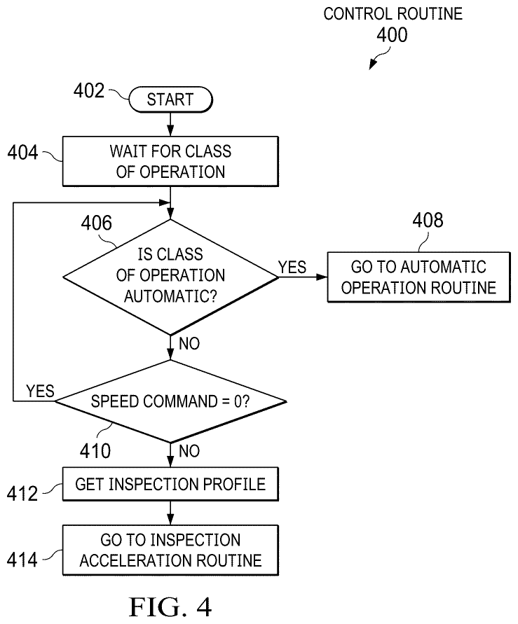

Referring then to FIGS. 4-13, methods of system operation will be further described. Preferably, the methods are achieved through software, resident in memory 208, which controls the operation of microprocessor 206. In general, the methods monitor the operation of the elevator during each run and collect data from the sensors which is used to adjust the instantaneous speed command based on one of four profiles. Each profile preferably includes a list of parameters as follows:
Contract Speed: This is the maximum speed possible and is used along with the other S-curve adjustment parameters to compute the cruising speed of each run.
Acceleration: Defines the maximum acceleration rate during the acceleration phase.
Jerk-In Acceleration: Sets the positive jerk rate (rate of acceleration increase) during the acceleration phase.
Jerk-Out Acceleration: Establishes the negative jerk rate (rate of acceleration decrease) during the acceleration phase.
Deceleration: Determines the maximum deceleration rate during the deceleration phase.
Jerk-In Deceleration: Assigns the negative jerk rate (rate of acceleration decrease) during the deceleration phase.
Jerk-Out Deceleration: Sets the positive jerk rate (rate of acceleration increase) during the deceleration phase.
Leveling Speed: This is the final speed of the elevator at the end of the S-curve before reaching the destination position.
Leveling Distance: Specifies the distance from the destination at which the car transitions to the leveling speed.

Referring then to FIG. 4, control routine 400 will be further described.

At step 402, the method begins.

At step 404, central controller 202 waits for an input from the keypad as to the class of operation. In a preferred embodiment, the class of operation can either be “automatic” or “inspection.” Once the input is received, the method moves to step 406.

At step 406, the microprocessor decides whether or not the class of operation is “automatic.” If so, the method moves to 408. If not, the method moves to step 410.

At step 408, the microprocessor moves to the automatic operation routine, as will be further described.

At step 410, the microprocessor decides whether or not a speed command has been entered on the keypad that is equal to zero. If so, the method returns to step 406. If not, the method moves to step 412.

At step 412, the microprocessor retrieves the inspection profile from memory.

In a preferred embodiment, the inspection profile comprises the following values.

| “Up” Parameter Set | “Down” Parameter Set |
|---|---|
| Jᵢₐ (Jerk-In Acceleration) = 1.5 f/s\hat{ }3 | Jᵢₐ (Jerk-In Acceleration) = 1.5 f/s\hat{ }3 |
| J₀ₐ (Jerk-Out Acceleration) = 1.5 f/s\hat{ }3 | J₀ₐ (Jerk-Out Acceleration) = 1.5 f/s\hat{ }3 |
| A (Acceleration) = 1 f/s\hat{ }2 | A (Acceleration) = 1 f/s\hat{ }2 |
| V_{c} (Contract Speed) = 300 fpm | V_{c} (Contract Speed) = 300 fpm |
| J_{id} (Jerk-In Deceleration) = 2 f/s\hat{ }3 | J_{id} (Jerk-In Deceleration) = 2 f/s\hat{ }3 |
| J_{od} (Jerk-Out Deceleration) = 0.8 f/s\hat{ }3 | J_{od} (Jerk-Out Deceleration) = 0.8 f/s\hat{ }3 |
| D (Deceleration) = 1 f/s\hat{ }2 | D (Deceleration) = 1 f/s\hat{ }2 |
| D_{L} (Leveling Distance) = 1 in | D_{L} (Leveling Distance) = 1 in |
| Vᵢ (Leveling Speed) = 10 fpm | Vᵢ (Leveling Speed) = 10 fpm |
| Inspection Speed = 50 fpm | Inspection Speed = 50 fpm |

At step 414, the method moves to the inspection acceleration routine, as will be further described.

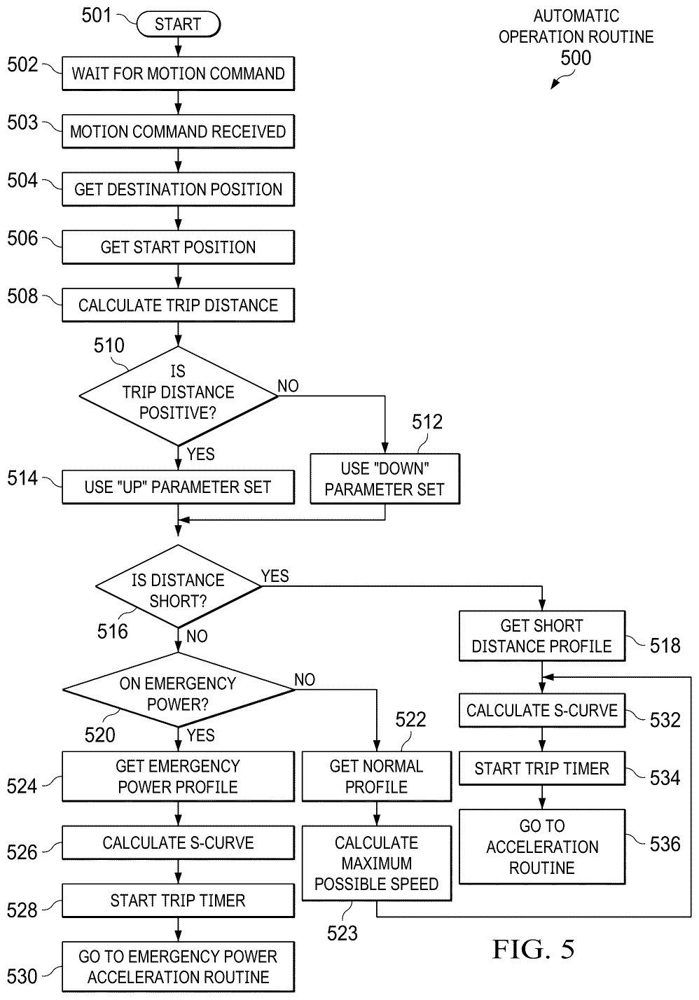

Referring to FIG. 5, automatic operation routine 500 will be further described.

At step 501, the method begins.

At step 502, the microprocessor waits for a motion command, typically received from a car control or a hall panel controller.

At step 503, a motion command is received, including a destination position.

At step 504, the microprocessor retrieves the destination position from the motion command.

At step 506, the microprocessor retrieves the car start position from either sensor 144 or pickup 115.

At step 508, the microprocessor calculates the trip distance by subtracting the start position from the destination position.

At step 510, the microprocessor decides whether or not the trip distance value is positive. If not, the method moves to step 512. If so, the method moves to step 514.

At step 512, the processor sets a flag indicating use of the “down” parameter set from the profile.

At step 514, the microprocessor sets a flag indicating that the “up” parameter set from the profile is to be used.

At step 516, the microprocessor decides whether or not the trip distance is considered “short.” In a preferred embodiment, the trip distance is considered short if it is less than five floors. However, in other embodiments, the trip distance may be considered short if it is any number of floors less than that required to reach the cruise start position, as will be further described. If the distance is considered short, the method moves to step 518. If not, the method moves to step 520.

At step 518, the microprocessor retrieves the “short distance” profile from memory. In a preferred embodiment, the short distance profile is as follows.

| “Up” Parameter Set | “Down” Parameter Set |
|---|---|
| Jᵢₐ (Jerk-In Acceleration) = 2 f/s\hat{ }3 | Jᵢₐ (Jerk-In Acceleration) = 2 f/s\hat{ }3 |
| J₀ₐ (Jerk-Out Acceleration) = 4 f/s\hat{ }3 | J₀ₐ (Jerk-Out Acceleration) = 4 f/s\hat{ }3 |
| A (Acceleration) = 3 f/s\hat{ }2 | A (Acceleration) = 3 f/s\hat{ }2 |
| V_{c} (Contract Speed) = 300 fpm | V_{c} (Contract Speed) = 300 fpm |
| J_{id} (Jerk-In Deceleration) = 2 f/s\hat{ }3 | J_{id} (Jerk-In Deceleration) = 2 f/s\hat{ }3 |
| J_{od} (Jerk-Out Deceleration) = 4 f/s\hat{ }3 | J_{od} (Jerk-Out Deceleration) = 4 f/s\hat{ }3 |
| D (Deceleration) = 3 f/s\hat{ }2 | D (Deceleration) = 3 f/s\hat{ }2 |
| D_{L} (Leveling Distance) = 1 in | D_{L} (Leveling Distance) = 1 in |
| Vᵢ (Leveling Speed) = 10 fpm | Vᵢ (Leveling Speed) = 10 fpm |

At step 532, the microprocessor calculates the initial S-curve, as will be further described.

At step 534, the microprocessor starts a trip timer, as will be further described.

At step 536, the method proceeds to the acceleration routine, as will be further describe.

At step 520, the microprocessor decides whether or not the system is running on “emergency power.” In the preferred embodiment, the microprocessor receives a message from one or more of the car panel controller, the hall panel controllers, or the motor room board, indicating that a power failure has occurred, or that generator or battery backup power has been activated. Such a message sets a flag in memory that is interpreted by the microprocessor at this step.

If so, the method moves to step 524. If not, the method moves to step 522.

At step 522, the microprocessor retrieves the “normal” profile from memory and moves to step 532. In a preferred embodiment, the normal profile is as follows.

| “Up” Parameter Set | “Down” Parameter Set |
|---|---|
| Jᵢₐ (Jerk-In Acceleration) = 2 f/s\hat{ }3 | Jᵢₐ (Jerk-In Acceleration) = 2 f/s\hat{ }3 |
| J₀ₐ (Jerk-Out Acceleration) = 2 f/s\hat{ }3 | J₀ₐ (Jerk-Out Acceleration) = 2 f/s\hat{ }3 |
| A (Acceleration) = 2 f/s\hat{ }2 | A (Acceleration) = 2 f/s\hat{ }2 |
| V_{c} (Contract Speed) = 300 fpm | V_{c} (Contract Speed) = 300 fpm |
| J_{id} (Jerk-In Deceleration) = 2 f/s\hat{ }3 | J_{id} (Jerk-In Deceleration) = 2 f/s\hat{ }3 |
| J_{od} (Jerk-Out Deceleration) = 0.8 f/s\hat{ }3 | J_{od} (Jerk-Out Deceleration) = 0.8 f/s\hat{ }3 |
| D (Deceleration) = 1 f/s\hat{ }2 | D (Deceleration) = 1 f/s\hat{ }2 |
| D_{L} (Leveling Distance) = 1 in | D_{L} (Leveling Distance) = 1 in |
| Vᵢ (Leveling Speed) = 10 fpm | Vᵢ (Leveling Speed) = 10 fpm |

At step 523, the microprocessor calculates the maximum possible speed for the run distance, as will be further described.

At step 524, the microprocessor retrieves the “emergency power” profile from memory. In a preferred embodiment, the emergency power profile is as follows.

| “Up” Parameter Set | “Down” Parameter Set |
|---|---|
| Jᵢₐ (Jerk-In Acceleration) = 1.8 f/s\hat{ }3 | Jᵢₐ (Jerk-In Acceleration) = 1.8 f/s\hat{ }3 |
| J₀ₐ (Jerk-Out Acceleration) = 1.8 f/s\hat{ }3 | J₀ₐ (Jerk-Out Acceleration) = 1.8 f/s\hat{ }3 |
| A (Acceleration) = 1.5 f/s\hat{ }2 | A (Acceleration) = 1.5 f/s\hat{ }2 |
| E-power Speed = 100 fpm | E-power Speed = 100 fpm |
| J_{id} (Jerk-In Deceleration) = 1.8 f/s\hat{ }3 | J_{id} (Jerk-In Deceleration) = 1.8 f/s\hat{ }3 |
| J_{od} (Jerk-Out Deceleration) = 1.8 f/s\hat{ }3 | J_{od} (Jerk-Out Deceleration) = 1.8 f/s\hat{ }3 |
| D (Deceleration) = 1.5 f/s\hat{ }2 | D (Deceleration) = 1.5 f/s\hat{ }2 |
| D_{L} (Leveling Distance) = 1 in | D_{L} (Leveling Distance) = 1 in |
| Vᵢ (Leveling Speed) = 10 fpm | Vᵢ (Leveling Speed) = 10 fpm |

At step 526, the microprocessor calculates the initial S-curve, as will be further described.

At step 528, the microprocessor starts the trip timer.

At step 530, the microprocessor moves to the emergency power acceleration routine, as will be further described.

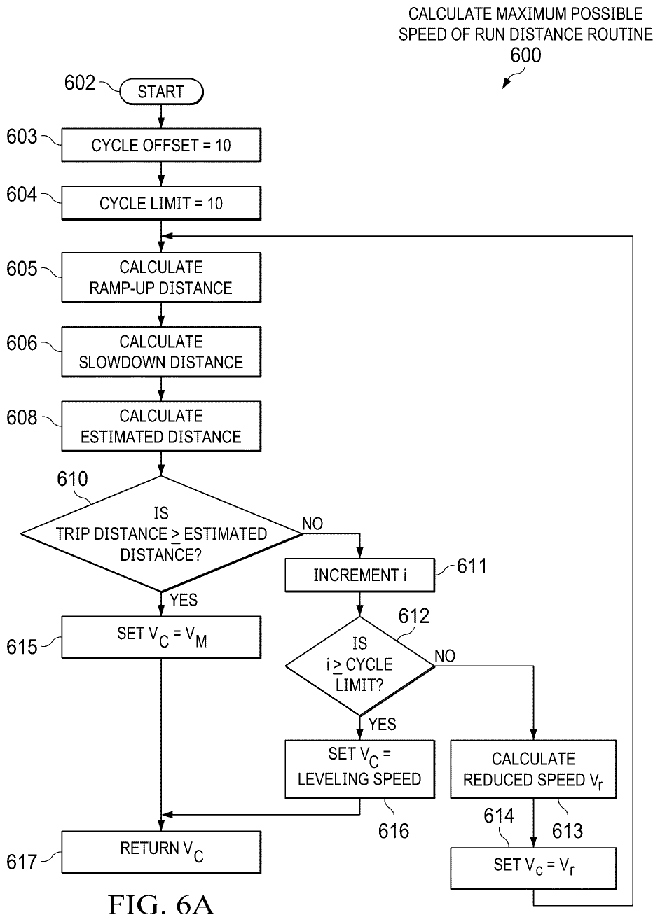

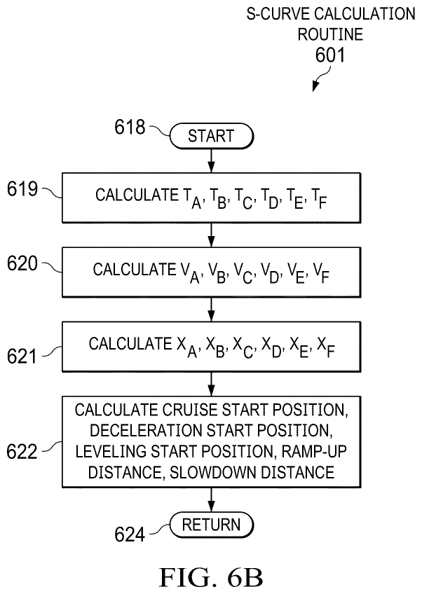

Referring to FIG. 6A, calculate maximum possible speed of run distance routine 600 will be further described.

At step 602, the method begins. In this method, a series of iterations is conducted to find an estimated distance less than or equal to the new requested destination and reduce maximum speed accordingly.

At step 603, the microprocessor sets a variable “cycle limit” to 10. This variable may assume other values.

At step 604, the microprocessor sets a counter variable “i” to 10. This variable may assume other values.

At step 605, the microprocessor calculates the ramp up distance, as will be further described.

At step 606, the microprocessor calculates the slowdown distance, as will be further described.

At step 608, the microprocessor calculates the estimated distance by adding the ramp up distance to the slowdown distance according to the following equation.

$$Estimated distance = ramp up distance + slowdown distance$$

At step 610, the microprocessor decides whether or not the trip distance is greater than or equal to the estimated distance. If not, the method moves to step 611. If so, the method moves to step 615.

At step 615, the microprocessor sets the contract speed, V_{c} equal to the maximum possible speed, Vₘ.

At step 611, the microprocessor increments the cycle counter “i” by 1.

At step 612, the microprocessor determines whether the cycle counter “i” has met or exceeded the cycle limit. If so, the method moves to step 616. If not, the method moves to step 613.

At step 613, the microprocessor calculates the value of the reduced speed “Vᵣ” by use of the following equation:

$${V}_{r} = {V}_{c} \times ( 1 - ( i \times cycle limit ) )$$

Where:
Vᵣ=reduced speed;
V_{c}=contract speed; and
i=counter variable.

At step 614, the microprocessor sets the V_{c} variable equal to the reduced speed, Vᵣ. The method then returns to step 605.

At step 616, the microprocessor sets the contact speed, V_{c} equal to the leveling speed, Vᵢ.

At step 617, the microprocessor returns the value V_{c}.

Referring to FIG. 6B, S-curve calculation routine 601 will be further described. In a preferred embodiment, this method calculates the time, velocity and position inflection points for an S-curve acceleration and deceleration profile, optimizing the smooth transition and precise control of elevator movements. The contact speed, V_{c}, is varied by other routines to Vᵣ, Vₘ, V_{sc}, V_{emergency}, V_{inspection}, V_{near terminal}, or V_{short floor}, which are reduced maximum speeds appropriate for different profiles, as will be further described.

At step 618, the method begins.

At step 619, the microprocessor calculates values for time inflection points Tₐ, T_{b}, T_{c}, T_{d}, Tₑ, and T_{f}, according to the following equations:

$${T}_{a} = \frac{A}{{J}_{ia}}$$

Where:
Tₐ=time at the beginning of constant acceleration;
A=acceleration; and
Jᵢₐ=jerk-in acceleration.

$${T}_{b} = \frac{{V}_{c}}{A} + 0.5 A ( \frac{1}{{J}_{ia}} - \frac{1}{{J}_{0 a}} )$$

Where:
T_{b}=time at the end of constant acceleration;
V_{c}=maximum possible cruising speed;
A=acceleration;
Jᵢₐ=jerk-in acceleration; and
J₀ₐ=jerk-out acceleration.

$${T}_{c} = \frac{{V}_{m}}{A} + 0.5 \times A ( \frac{1}{{J}_{id}} - \frac{1}{{J}_{od}} )$$

Where:
T_{c}=time at the beginning of cruising phase;
V_{c}=maximum possible cruising speed;
A=acceleration;
Jᵢₐ=jerk-in acceleration; and
J₀ₐ=jerk-out acceleration.

$${T}_{d} = \frac{( {V}_{c} - {V}_{i} )}{D} + 0.5 \times D ( \frac{1}{{J}_{id}} + \frac{1}{{J}_{od}} )$$

Where:
T_{d}=time at the end of cruising phase;
V_{c}=maximum possible cruising speed;
Vᵢ=leveling speed;
D=deceleration;
J_{id}=jerk-in deceleration; and
J_{od}=jerk-out deceleration.

$${T}_{e} = \frac{( {V}_{c} - {V}_{i} )}{D} + 0.5 \times D ( \frac{1}{{J}_{id}} + \frac{1}{{J}_{od}} )$$

Where:
Tₑ=time at the beginning of deceleration phase;
V_{c}=maximum possible cruising speed;
Vᵢ=leveling speed;
D=deceleration;
J_{id}=jerk-in deceleration; and
J_{od}=jerk-out deceleration.

$${T}_{f} = \frac{D}{{J}_{id}}$$

Where:
T_{f}=time at the end of constant deceleration;
D=deceleration; and
J_{id}=jerk-in deceleration.

At step 620, the microprocessor calculates values for velocity inflection points Vₐ, V_{b}, V_{c}, V_{d}, Vₑ, V_{f}, according to the following equations:

$${V}_{a} = 0.5 \times {J}_{ia} \times ( {T}_{a}^{2} )$$

Where:
Vₐ=velocity at beginning of constant acceleration;
Jᵢₐ=jerk-in acceleration; and
Tₐ=time at the beginning of constant acceleration.

$${V}_{b} = A ( {T}_{b} - {T}_{a} ) + {V}_{a}$$

Where:
V_{b}=velocity at end of constant acceleration;
T_{b}=time at end of constant acceleration; and
A=acceleration.
   V_{c}=maximum possible cruising speed
   V_{d}=maximum possible cruising speed

$${V}_{e} = D ( {T}_{e} - {T}_{f} ) + {V}_{f}$$

Where:
Vₑ=velocity at beginning of constant deceleration;
D=deceleration;
Tₑ=time at beginning of constant deceleration; and
V_{f}=velocity at end of constant deceleration.

$${V}_{f} = 0.5 \times {J}_{id} \times ( {T}_{f}^{2} ) + {V}_{i}$$

Where:
V_{f}=velocity at end of constant deceleration;
J_{id}=jerk-in deceleration;
T_{f}=time at end of constant deceleration; and
Vᵢ=leveling speed.

At step 621, the microprocessor calculates values for position inflection points Xₐ, X_{b}, X_{c}, X_{d}, Xₑ, and X_{f}, according to the following equations:

$${X}_{a} = {J}_{ia} \times \frac{( {T}_{a}^{2} )}{6}$$

Where:
Xₐ=position at beginning of constant acceleration;
Jᵢₐ=jerk-in acceleration; and
Tₐ=elapsed time at beginning of constant acceleration.

$${X}_{b} = 0.5 A \times ( {T}_{b}^{2} ) + {V}_{a} \times ( {T}_{b} - {T}_{a} ) + {X}_{a}$$

Where:
X_{b}=position at end of constant acceleration;
A=acceleration;
T_{b}=elapsed time at end of constant acceleration;
Vₐ=velocity at beginning of constant acceleration; and
Tₐ=elapsed time at beginning of constant acceleration.

$${X}_{c} = 0.5 \times A \times ( {( {T}_{c} - {T}_{b} )}^{2} ) - {J}_{oa} \times \frac{( {( {T}_{c} - {T}_{b} )}^{3} )}{6} + {V}_{b} \times ( {T}_{c} - {T}_{b} ) + {X}_{b}$$

Where:
X_{c}=position at beginning of cruising phase;
A=acceleration;
T_{b}=elapsed time at end of constant acceleration;
V_{b}=velocity at end of constant acceleration;
T_{c}=elapsed time at beginning of cruising phase;
X_{b}=position at end of constant acceleration; and
Jₒₐ=jerk-out acceleration.

$${X}_{d} = 0.5 \times D \times ( {( {T}_{d} - {T}_{e} )}^{2} ) - {J}_{od} \times \frac{( {( {T}_{d} - {T}_{e} )}^{3} )}{6} + {V}_{e} \times ( {T}_{d} - {T}_{e} ) + {X}_{e}$$

Where:
X_{d}=position at end of cruising phase;
D=deceleration;
T_{d}=elapsed time at end of cruising phase;
Tₑ=elapsed time at beginning of constant deceleration;
J_{od}=jerk-out deceleration;
Vₑ=velocity at beginning of constant deceleration; and
Xₑ=position at beginning of constant deceleration.

$${X}_{e} = 0.5 \times D \times {( {T}_{e} - {T}_{f} )}^{2} + {V}_{a} \times ( {T}_{e} - {T}_{f} ) + {X}_{f}$$

Where:
Xₑ=position at beginning of constant deceleration;
D=deceleration;
Tₑ=elapsed time at beginning of constant deceleration;
T_{f}=time at end of constant deceleration; and
X_{f}=position at end of constant deceleration.

$${X}_{f} = {J}_{id} \times \frac{( {T}_{f}^{3} )}{6} + {V}_{i}$$

Where:
X_{f}=position at end of constant deceleration;
J_{id}=jerk-in deceleration;
T_{f}=time at end of constant deceleration; and
Vᵢ=leveling speed.

At step 622, the microprocessor calculates values for the cruise start position, the deceleration start position, the ramp up distance, the ramp down distance, and the leveling start position, according to the following equations:

$${X}_{c} = cruise start position$$

Where:
X_{g}=leveling distance.

At step 624, the method concludes and returns.

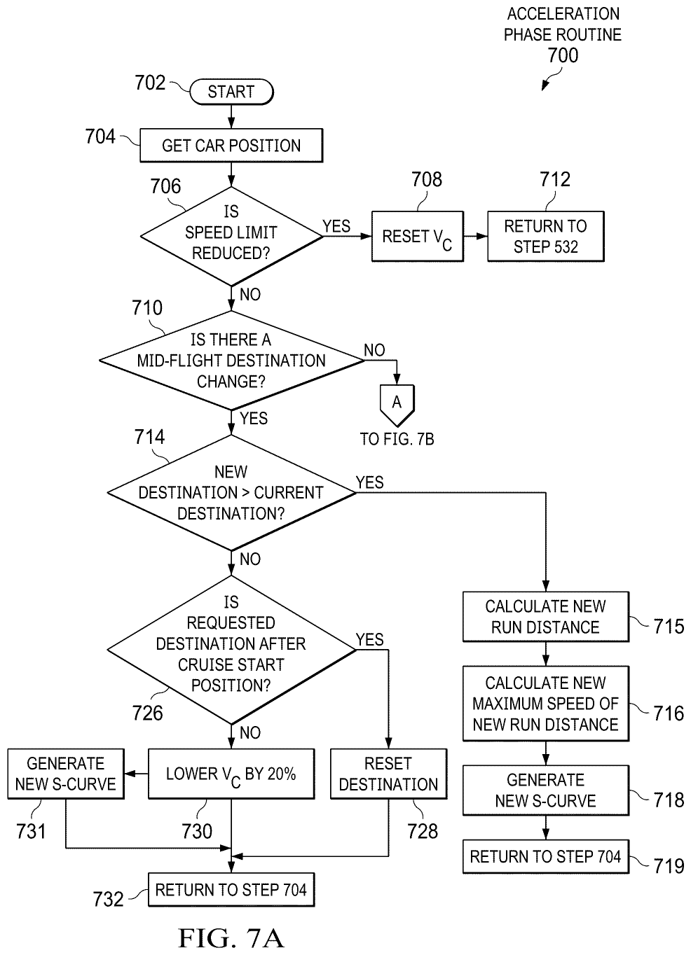

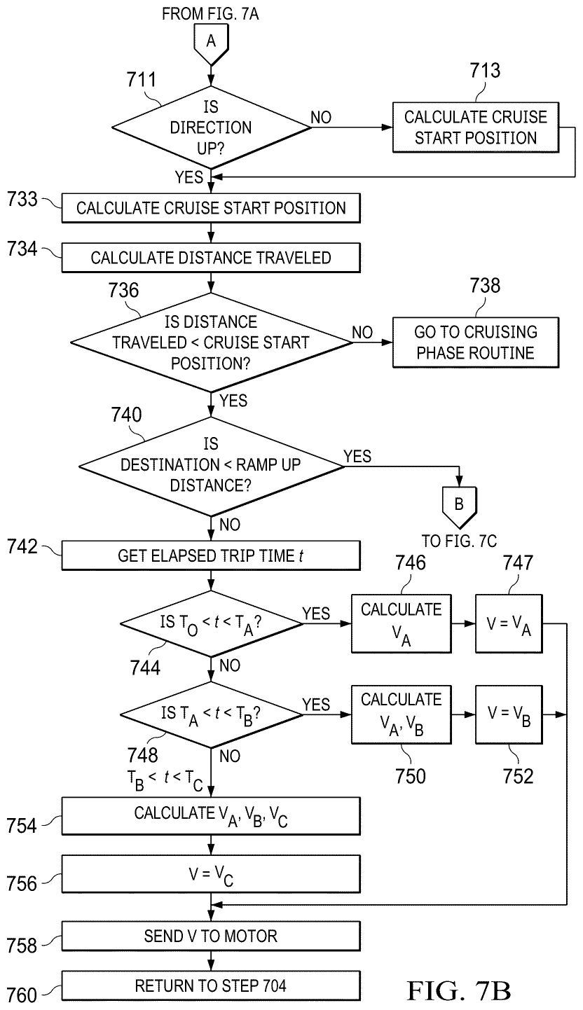

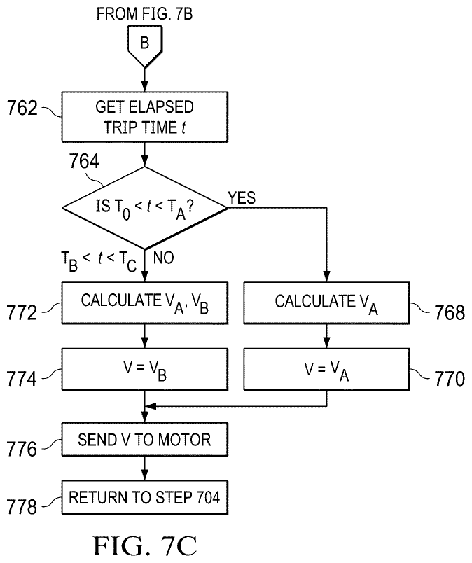

Referring then to FIGS. 7A, 7B and 7C, acceleration phase routine 700 will be further described. In a preferred embodiment, this routine controls motor speed during the acceleration phase, compensating for changes in destination and reduced speed limits using the initial S-curve and modifying it when necessary.

At step 702, the method begins.

At step 704, the microprocessor retrieves a value indicating the position of the elevator car by retrieving position data from sensor 144 or pickup 115.

At step 706, the processor determines whether or not the maximum speed, V_{c}, has been reduced to a lower speed, such as Vₘ or Vᵢ, as previously described. If so, the method moves to step 708. If not, the method moves to step 710.

At step 708, if not already done so, the maximum speed, V_{c}, is then reset to the lower speed, e.g., Vₘ or Vᵢ.

At step 712, the method returns to step 532, as previously described.

At step 710, the microprocessor polls the car panel controller and the hall panel controllers to determine whether or not a mid-flight destination change has been commanded. If not, the method moves to step 711. If so, the method moves to step 714.

At step 714, the processor determines whether or not the new destination is greater than the current destination in memory. In a preferred embodiment, the absolute value of the difference is used so as to compensate for the elevator car direction, up or down. If so, the processor moves to step 715. If not, the processor moves to step 726.

At step 715, the processor calculates a new run distance according to the following equation:

$$New run distance = ( new destination - crusing start position )$$

At step 716, the processor calculates the new maximum speed of the new run distance, as previously described. In a preferred embodiment, the step is carried out by repeating method 600.

At step 718, the microprocessor regenerates a new S-curve, as previously described. In a preferred embodiment, this step is accomplished by repeating method 601.

At step 719, the microprocessor then returns to step 704.

At step 726, the microprocessor determines whether or not the elevator car will arrive at the new requested destination before or after the cruise start position. If so, the method moves to step 728. If not, the method moves to step 730.

At step 728, the microprocessor resets the destination position to the new destination.

At step 730, the processor lowers the maximum speed value in V_{c} by 20%, and moves to step 732.

At step 731, the microprocessor regenerates a new S-curve, as previously described. In a preferred embodiment, this step is accomplished by method 601.

At step 732, the microprocessor returns to step 504.

At step 711, the microprocessor checks a flag to determine whether or not the direction of travel is up. If so, the method moves to step 733. If not, the method moves to step 713.

At step 733, the microprocessor calculates the cruising start position according to the following equation.

$$Crushing start position = actual distance - ramp up distance$$

The method then moves to step 734.

At step 713, the microprocessor calculates the cruise start position according to the following equation.

$$Crushing start position = actual distance + ramp up distance$$

The method then moves to step 734.

At step 734, the processor calculates the distance traveled as previously described.

At step 736, the processor determines whether or not the distance traveled is less than the cruise start position. If not, the processor moves to step 738. If so, the processor moves to step 740.

At step 738, the processor moves to the cruising phase routine, as will be further described.

At step 740, the processor determines whether or not the destination position is less than the ramp up distance. If not, the moves to step 742. If so, the processor moves to step 762. The ramp up distance is calculated as previously described.

At step 742, the microprocessor retrieves the elapsed trip time from memory.

At step 744, the processor determines whether or not the trip time is between T₀ and Tₐ, according to the following equation.

$${T}_{0} \leq t < {T}_{a}$$

At T₀, the initial start velocity is zero.

If so, the processor moves to step 746. If not, the processor moves to step 748.

At step 746, the processor calculates the value of Vₐ, as previously described.

At step 747, the processor sets the value of V equal to Vₐ and moves to step 758.

At step 748, the processor determines whether or not the elapsed trip time is between the values of Tₐ and T_{b}, according to the following equation.

$${T}_{a} \leq t < {T}_{b}$$

If so, the processor moves to step 750. If not, the processor moves to step 754.

At step 750, the processor calculates the values of Vₐ and V_{b}, as previously described.

At step 752, the processor sets the value of V equal to V_{b} and moves to step 758.

At step 754, for the condition where the elapsed trip time, t, is between the values of T_{b} and T_{c}, the processor calculates the values of Vₐ, V_{b} and Vₑ, as previously described.

At step 756, the processor sets the value of V to V_{c}.

At step 758, the processor sends the value of V to the motor as an instantaneous speed command, in order to set the motor speed.

At step 760, the processor returns to step 704.

At step 762, the processor retrieves the elapsed trip time, t, from memory.

At step 764, the processor determines whether the elapsed time, t, is between the values of T₀ and Tₐ, according to the following equation.

$${T}_{0} \leq t < {T}_{a}$$

If so, the processor moves to step 768. If not, the processor moves to step 772.

At step 768, the processor calculates the value of Vₐ, as previously described.

At step 770, the processor sets the value of V to Vₐ and moves to step 776.

As step 772, for the condition where the elapsed trip time, t, is between the values of T_{b} and Tₑ, the processor calculates the values of Vₐ and V_{b}, as previously described.

At step 774, the processor sets the value of V to V_{b}.

At step 776, the value of V is sent to the motor to set the motor speed.

At step 778, the processor returns to step 704.

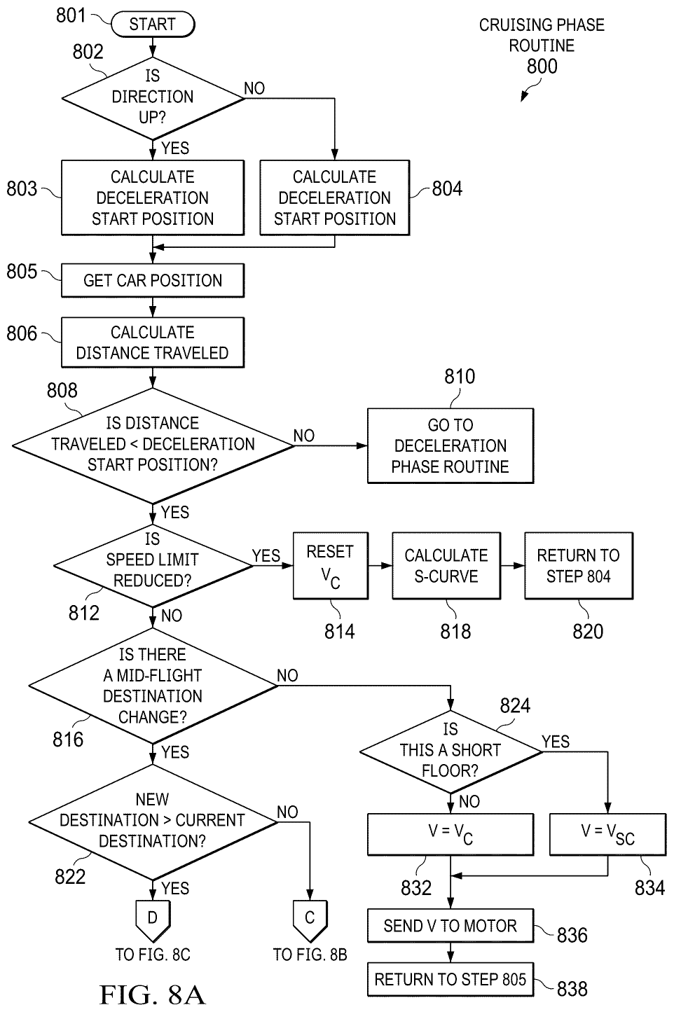

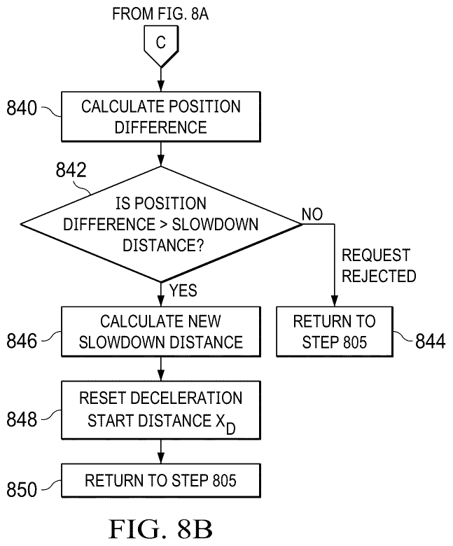

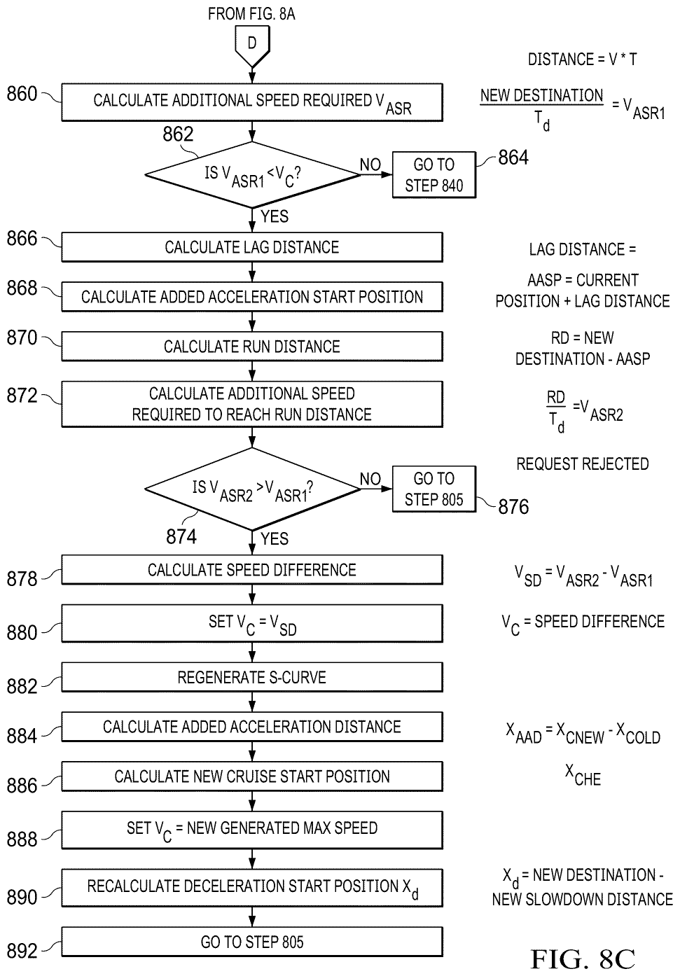

Referring then to FIGS. 8A, 8B and 8C, cruising phase routine 800 will be further described. In a preferred embodiment, this routine controls the motor speed during the cruising phase, compensating for changes in destination and reduced speed limits using the initial S-curve and modifying it when necessary.

At step 801, the method begins.

At step 802, the processor determines whether or not the direction of travel is up, by checking preset flags, as previously described. If so, the method moves to step 803. If not, the methods moves to step 804.

At step 803, the processor calculates the deceleration start position according to the following equation.

$$Deceleration start position = actual distance - slowdown distance$$

The method then moves to step 805.

At step 804, the microprocessor calculates the deceleration start position according to the following equation.

$$Deceleration start position = actual distance + slowdown distance$$

The method then moves to step 805.

At step 805, the processor retrieves the elevator car position from sensor 144 or pickup 115.

At step 806, the processor calculates the distance traveled by the elevator car, as previously described.

At step 808, the processor determines whether or not the distance traveled is less than the deceleration start position, using the absolute value, as previously described. If not, the method moves to step 810. If so, the method moves to step 812.

At step 810, the processor moves to the deceleration phase routine, as will be further described.

At step 812, the processor determines whether or not the maximum speed V_{c} has been reduced to Vₘ, as previously described. If so, the method moves to step 814. If not, the method moves to step 816.

At step 814, the processor resets V_{c} to the lower speed.

At step 818, the processor recalculates the S-curve, preferably according to method 601, as previously described.

At step 820, the processor returns to step 804.

At step 816, the processor determines whether or not there has been a “mid-flight” destination change by receiving an instruction from the car panel controller or one of the hall panel controllers. If not, the method moves to step 824. If so, the method moves to step 822.

At step 822, the microprocessor determines whether or not the new destination is greater than the current destination, using the absolute value. If not, the processor moves to step 840, if so the microprocessor moves to step 860.

At step 866, the microprocessor returns to step 804.

At step 824, the microprocessor determines whether or not the destination is a “short floor” by referring to a table in memory. If the destination is a short floor, then the microprocessor moves to step 834. If not, the microprocessor moves to step 832.

At step 834, V is set to the short floor maximum velocity, V_{sc}, and the microprocessor moves to step 836. V_{sc} is determined by referencing a table in memory. V_{sc} is always below the contact speed V_{c}.

At step 832, the variable V is set to the maximum speed V_{c}.

At step 836, the value of V is sent to the motor to set the motor speed.

At step 838, the microprocessor returns to step 804.

At step 840, the microprocessor calculates a position difference according to the following equation.

$$position difference = new requested destination - current position$$

At step 842, the microprocessor decides whether or not the position difference is greater than the slowdown distance. If not, the method moves to step 844. If so, the method steps moves to step 846.

At step 844, the request is rejected and the method returns to step 805.

At step 846, the microprocessor calculates a new slowdown position according to the following equation.

$$new slowdown position = requested destination - initial slowdown position$$

At step 848, the microprocessor resets the deceleration start position, X_{d}, to the new slowdown position.

At step 850, the microprocessor returns to step 805.

At step 860, the microprocessor calculates additional speed required, Vₐₛᵣ₁, according to the following equation:

$${V}_{asr 1} = \frac{new destination}{{T}_{g}}$$

Where:
Vₐₛᵣ₁=additional speed required; and
T_{g}=time to end of deceleration phase.

At step 862, the microprocessor decides whether or not the additional speed required, Vₐₛᵣ₁, is less than the contract speed, V_{c}. If not, the microprocessor moves to step 864. If so, the microprocessor moves to step 866.

At step 864, the method returns to step 840.

At step 866, the microprocessor calculates lag distance according to the following equation:

$$lag distance = 1 sec \times {V}_{max}$$

Where:
Vₘₐₓ=Vₐₛᵣ₁

At step 868, the microprocessors calculates the added acceleration start position according to the following equation:

$$A A S P = current car position + lag distance$$

Where:
AASP=added acceleration start position.

At step 870, the microprocessors calculates the run distance according to the following equation:

$${R}_{d} = new desitnation position A A S P$$

Where:
R_{d}=run new destination position=requested destination AASP=added acceleration start position.

At step 872, the microprocessor calculates additional speed required to reach the run distance according to the following equation:

$${V}_{asr 2} = \frac{{R}_{d}}{{T}_{g}}$$

Where:
Vₐₛᵣ₂=new maximum speed to reach run distance;
R_{d}=run distance; and
T_{g}=time to end of deceleration phase.

At step 874, the microprocessor decides whether or not the newly generated maximum speed, Vₐₛᵣ₂, is greater than the original maximum speed Vₐₛᵣ₁. If not, the method moves to step 876. If so, the method moves to step 878.

At step 876, the request is rejected and the method returns to step 805.

At step 878, the microprocessor calculates his speed difference according to the following equation:

$$SD = {V}_{asr 2} - {V}_{asr 1}$$

Where:
SD=speed difference;
Vₐₛᵣ₂=new maximum speed to reach run distance; and
Vₐₛᵣ₁=old maximum speed to reach run distance.

At step 880, the microprocessor sets V_{c} to V_{sd}.

At step 882, the microprocessor regenerates the S-curve, as previously described, using the new value of V_{c} set to V_{sd}.

At step 884, the microprocessor calculates the added acceleration distance using the new S-curve speed equations, as previously described.

At step 886, the microprocessor calculates a new cruise start position.

At step 888, the microprocessor sets the maximum speed, V_{c}, to the newly generated max speed Vₐₛᵣ₂.

At step 890, the microprocessor recalculates the deceleration start position, X_{d}, as previously described.

At step 892, the method returns to step 805.

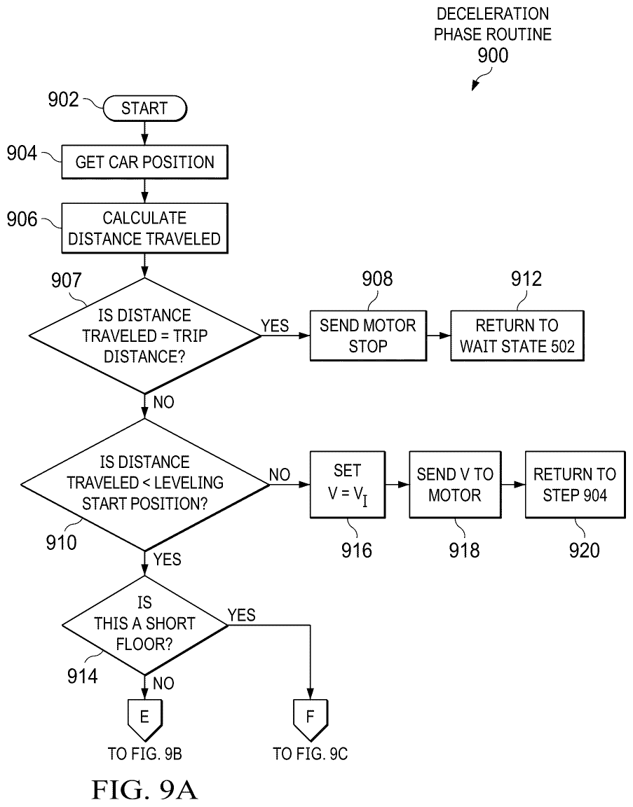

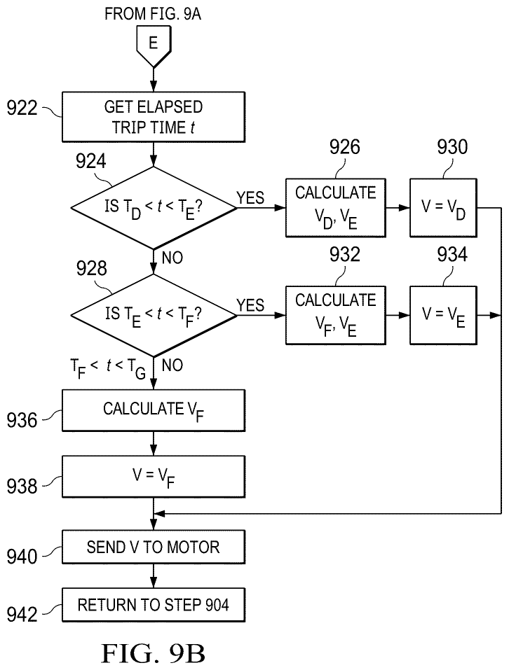

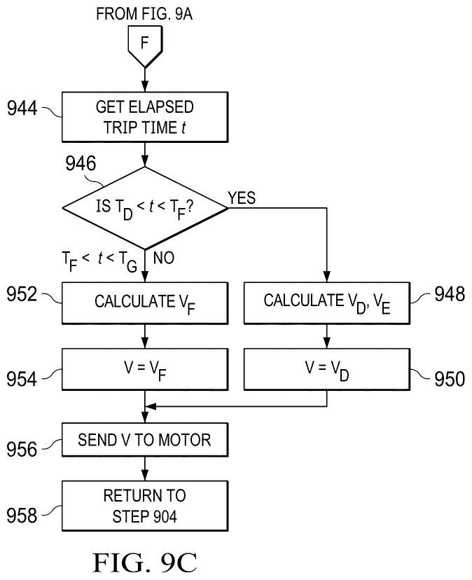

Referring then to FIGS. 9A, 9B and 9C, deceleration phase routine 900 will be further described. In a preferred embodiment, this routine controls the motor speed during the deceleration phase, compensating for changes in destination and reduced speed limits, using the initial S-curve and modifying it as necessary.

At step 902, the method begins.

At step 904, the microprocessor determines the elevator car position by retrieving data from sensor 144 or pickup 115.

At step 906, the microprocessor calculates the distance traveled, as previously described.

At step 907, the microprocessor determines whether or not the distance traveled is equal to the trip distance. The trip distance is returned from memory and preferably is calculated according to the following equation:

$$trip distance = {X}_{g} + leveling distance$$

Where:
X_{g}=leveling start position.

If so, the method moves to step 908. If not, the method moves to step 910.

At step 908, the microprocessor sends a motor stop command to the motor.

At step 912, the microprocessor returns to wait state 502.

At step 910, the microprocessor determines whether or not the distance traveled is less than the leveling start position.

If not, the method moves to step 916. If so, the method moves to step 914.

At step 916, the microprocessor sets the variable V to Vᵢ, the leveling speed. At step 918, the value of V is sent to the motor to set the motor speed.

At step 920, the microprocessor returns to step 904.

At step 914, the microprocessor determines whether or not the destination is a short floor, as previously described.

If not, the method moves to step 922. If so, the method moves to step 944.

At step 922, the microprocessor retrieves the elapsed trip time, t, from memory.

At step 924, the microprocessor determines whether or not the value of, t, is between the value of T_{d} and Tₑ, according to the following equation.

$${T}_{d} < t < {T}_{e}$$

If not, the method moves to step 928. If so, the method moves to step 926.

At step 926, the microprocessor calculates the value of V_{d}, and Vₑ, as previously described.

At step 930, the microprocessor sets the value of V to V_{d} and moves to step 940.

At step 928, the microprocessor determines whether the elapsed trip time, t, is between the values of Tₑ and T_{f} according to the following equation.

$${T}_{e} < t < {T}_{f}$$

If so, the method moves to step 932. If not, the method moves to step 936.

At step 932, the microprocessor calculates the value of Vₑ and V_{f}, as previously described.

At step 934, the value of V is set to Vₑ and the method moves to step 940.

At step 936, for the condition where the elapsed trip time, t, is between the values of T_{f} and T_{g}, the microprocessor calculates the value of V_{f}, as previously described.

At step 938, the value V is set to V_{f} and the microprocessor moves to step 940.

At step 940, the value of V is sent to the motor to set the motor speed.

At step 942, the method returns to step 904.

At step 944, the microprocessor retrieves the elapsed trip time, t.

At step 946, the microprocessor determines whether the elapsed trip time is between the value of T_{d} and Tₑ according to the following equation.

$${T}_{0} < t < {T}_{f}$$

If so, the microprocessor moves to step 948. If not, the microprocessor moves to step 952.

At step 948, the microprocessor calculates the values of V_{d} and Vₑ, as previously described.

At step 950, the microprocessor sets the value of V to V_{d} and moves to step 956.

At step 952, for the condition where the elapsed trip time, t, is between the values of T_{f} and T_{g}, the microprocessor calculates the value of V_{f}, as previously described.

At step 954, the microprocessor sets the value of V to V_{f} and moves to step 956.

At step 956, the value of V is sent to the motor to set the motor speed. At step 958, the microprocessor returns to step 904.

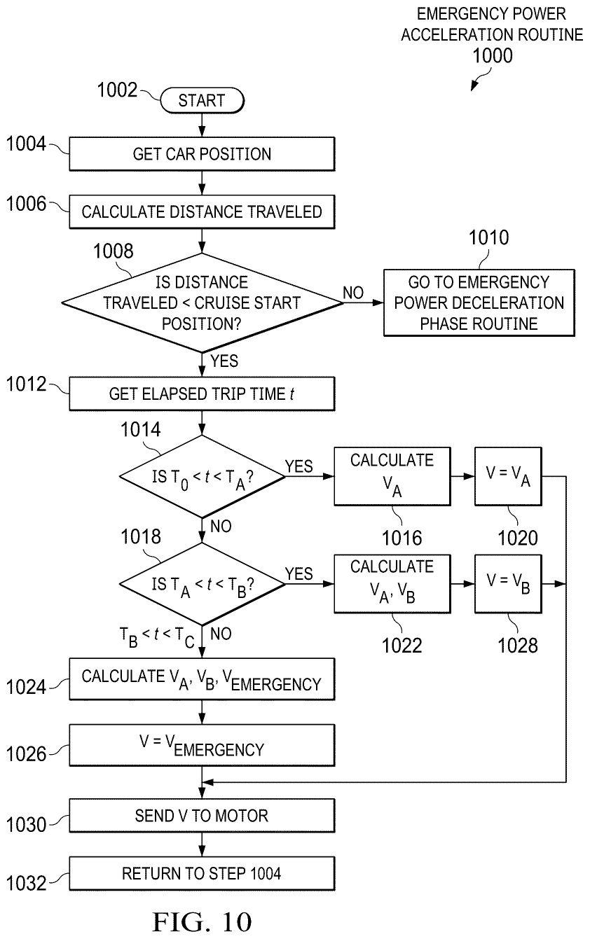

Referring then to FIG. 10, emergency power acceleration routine 1000 will be further described. In a preferred embodiment, this routine controls the motor speed during the acceleration phase when the maximum speed, and other parameters may be reduced or modified to facilitate reduced power consumption from batteries or back-up generators.

At step 1002, the method begins.

At step 1004, the microprocessor retrieves the value of the elevator car position by polling sensor 144 or pickup 115.

At step 1006, the microprocessor calculates the distance traveled, as previously described.

At step 1008, the microprocessor determines whether or not the distance traveled is less than the cruise start position. If not, the microprocessor moves to step 1010. If so, the processor moves to step 1012.

At step 1010, the microprocessor moves to the emergency power deceleration phase routine, as will be further described.

At step 1012, the microprocessor retrieves the elapsed trip time, t.

At step 1014, the microprocessor determines whether or not the elapsed trip time, t, is between the values of T₀ and Tₐ according to the following equation.

$${T}_{0} \leq t < {T}_{a}$$

If so, the microprocessor moves to step 1016. If not, the microprocessor moves to step 1018.

At step 1016, the microprocessor calculates the value of Vₐ, as previously described.

At step 1020, the microprocessor sets the value of V to Vₐ and moves to step 1030.

At step 1018, the microprocessor determines whether or not the elapsed trip time, t, is between the values of Tₐ and T_{b} according to the following equation.

$${T}_{a} < t < {T}_{b}$$

If so, the microprocessor moves to step 1022. If not, the microprocessor moves to step 1024.

At step 1022, the microprocessor calculates the value of Vₐ and V_{b}, as previously described.

At step 1028, the microprocessor sets the value of V to V_{b}, then moves to step 1030.

At step 1024, the microprocessor for the condition where the elapsed trip time, t, is between the values of T_{b} and T_{c}, the microprocessor calculates the value of Vₐ, V_{b} and V_{c}, as previously described. V_{c} in this instance is set as V_{emergency}, the maximum velocity for emergency conditions.

At step 1026, the microprocessor sets the value of V to V_{emergency} and moves to step 1030.

At step 1030, the value of V is sent to the motor set the motor speed.

At step 1032, the microprocessor returns to step 1004.

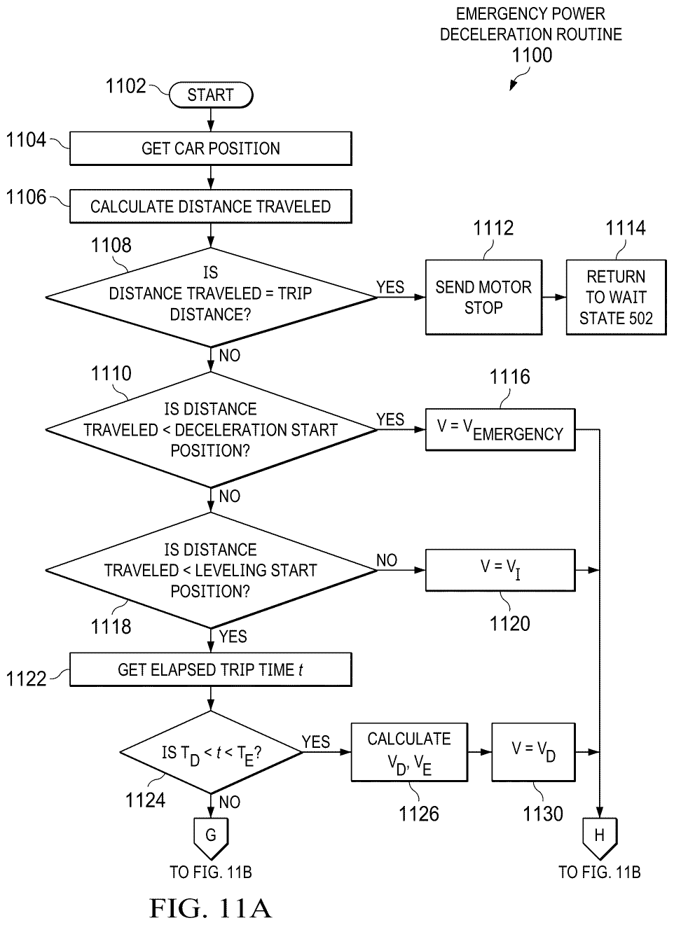

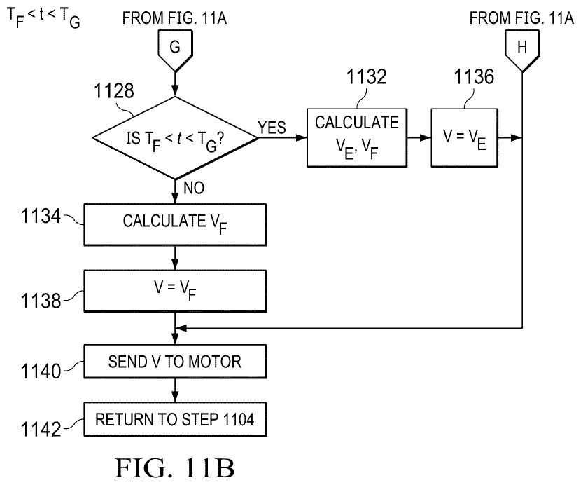

Referring to FIGS. 11A and 11B, emergency power deceleration routine 1100 will be further described. In a preferred embodiment, this routine controls the motor speed during the cruising and deceleration phases when the maximum speed and other parameters may be reduced or modified to facilitate reduced power consumption.

At step 1102, the method begins.

At step 1104, the microprocessor retrieves the elevator car position by polling sensor 144 or pickup 115.

At step 1106, the microprocessor calculates the distance traveled, as previously described.

At step 1108, the microprocessor determines whether or not the distance traveled is equal to the trip distance. If not, the method moves to step 1110. If so, the method moves to step 1112.

At step 1112, the microprocessor sends a stop command to the motor.

At step 1114, the microprocessor returns to wait state 502.

At step 1110, the microprocessor determines whether or not the distance traveled is less than the deceleration start position. If so, the processor moves to step 1116. If not, the microprocessor moves to step 1118.

At step 1116, the value of V is set to the value of V_{emergency} in memory and the method moves to step 1140.

At step 1118, the microprocessor determines whether or not the distance traveled is less than the leveling start position. If not, the microprocessor moves to step 1120. If so, the processor moves to step 1122.

At step 1120, the microprocessor sets the value of V to Vᵢ, the leveling speed, and moves to step 1140.

At step 1122, the microprocessor retrieves the elapsed trip time, t, from memory.

At step 1124, the microprocessor determines whether or not the elapsed trip time, t, is between the values of T_{d} and Tₑ, according to the following equation.

$${T}_{0} < t < {T}_{e}$$

If so, the microprocessor moves to step 1126. If not, the microprocessor moves to step 1128.

At step 1126, the microprocessor calculates the value of V_{d} and Vₑ, as previously described.

At step 1130, the microprocessor sets the value of V to Vₐ and moves to step 1140.

At step 1128, the microprocessor determines whether or not the value of the elapsed trip time, t, is between the value of Tₑ and T_{f}, according to the following equation.

$${T}_{e} < t < {T}_{f}$$

If so, the microprocessor moves to step 1132. If not, the microprocessor moves to step 1134.

At step 1132, the microprocessor calculates the values of Vₑ and V_{f}, as previously described.

At step 1136, the microprocessor sets the value of V to Vₑ and moves to step 1140.

At step 1134, the microprocessor for the condition where the elapsed trip time T is between the values of T_{f} and T_{g} the microprocessor calculates the value of V_{f}, as previously described.

At step 1138, the microprocessor sets the value of V to V_{f} and moves step 1140.

At step 1140, the value of V is sent to the motor to set the motor speed. At step 1142, the microprocessor returns to step 1104.

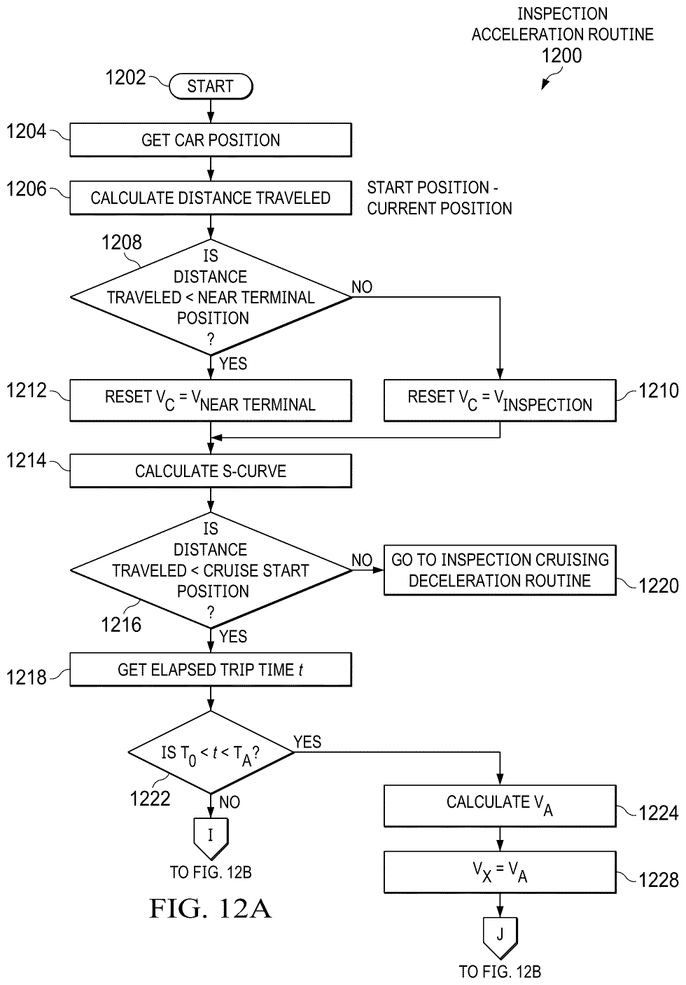

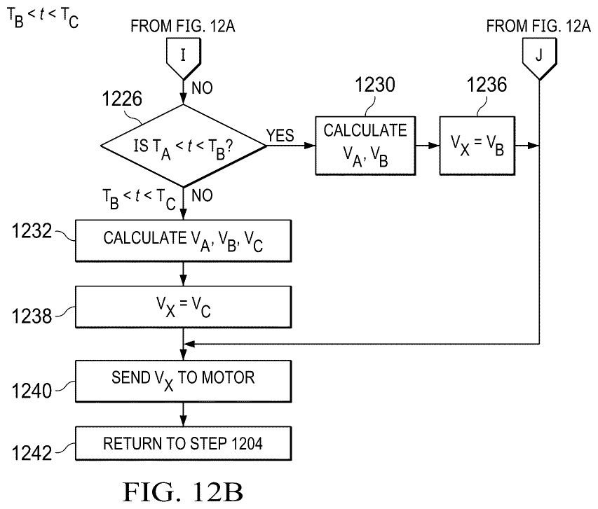

Referring then to FIGS. 12A and 12B, inspection acceleration routine 1200 will be further described. In a preferred embodiment, this routine controls the motor speed during the acceleration phase, when the maximum speed, and other parameters may be reduced or modified to facilitate elevator inspection procedures when heightened safety is a paramount concern.

The method begins at step 1202.

At step 1204, the microprocessor retrieves the elevator car position by polling sensor 144 or pickup 115.

At step 1206, the microprocessor calculates the distance traveled, as previously described.

At step 1208, the microprocessor determines whether or not the distance traveled is less than the near terminal position. In a preferred embodiment, the “near terminal position” is an elevator car position within 2 inches to 2 feet of the top or the bottom of the elevator travel. This value is dependent on the mechanics of the particular elevator involved. The V_{near terminal} value is stored in memory at system startup.

If not, the processor moves to step 1210. If so, the microprocessor moves to step 1212.

At step 1210, the microprocessor resets the value of V_{c} to V_{inspection} and moves to step 1214. V_{inspection} is stored in memory at system startup.

At step 1212, the microprocessor resets the value of V_{c} to V_{near terminal} and moves to step 1214.

At step 1214, the microprocessor recalculates the S-curve. In a preferred embodiment the S-curve is recalculated according to method 601.

At step 1216, the microprocessor determines whether or not the distance traveled is less than the cruise start position. If not, the processor moves to step 1220. If so, the microprocessor moves to step 1218.

At step 1218, the microprocessor moves to the inspection cruising deceleration routine, as will be further described.

At step 1218, the microprocessor retrieves the elapsed trip time, t.

At step 1222, the microprocessor determines whether or not the value of, t, is between the value of T₀ and Tₐ, according to the following equation.

$${T}_{0} \leq t < {T}_{a}$$

If so, the microprocessor moves to step 1224. If not, the microprocessor moves to step 1226.

At step 1224, the microprocessor calculates the value of Vₐ, as previously described.

At step 1228, the value of Vₓ is set to the value of Vₐ and the microprocessor moves to step 1240. Vₓ is the instantaneous velocity of the elevator car, which is stored in memory for later use.

At step 1226, the microprocessor determines whether or not the value of elapsed trip time, t, is between Tₐ and T_{b}, according to the following equation.

$${T}_{a} < t < {T}_{b}$$

If so, the microprocessor moves to step 1230. If not, the microprocessor moves to step 1232.

At step 1230, the microprocessor calculates the values of Vₐ and V_{b}, as previously described.

At step 1236, the microprocessor sets the value of Vₓ to V_{b} and moves to step 1240.

At step 1232, for the condition where the elapsed trip time, t, is between T_{b} and T_{c}, the microprocessor calculates the values of Vₐ, V_{b}, and V_{c}, as previously described. Here V_{c} is set to V_{inspection}.

At step 1238, the microprocessor sets the value of Vₓ to V_{inspection}.

At step 1240, the microprocessor sends the value of Vₓ to the motor to set the motor speed.

At step 1242, the microprocessor returns to step 1204.

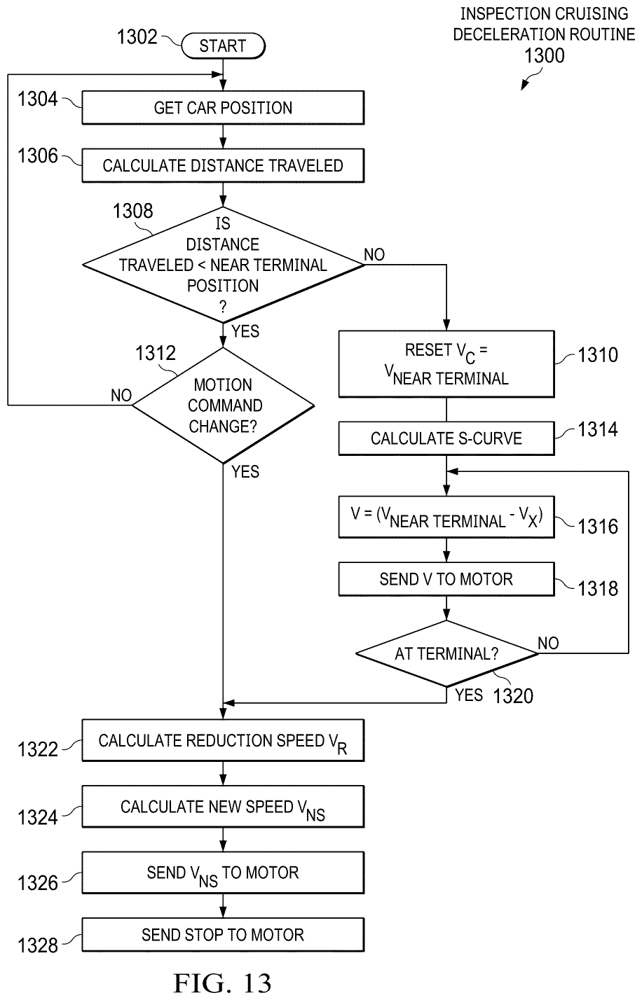

Referring then to FIG. 13, inspection cruising deceleration routine 1300 will be further described.

At step 1302, the method begins.

At step 1304, the microprocessor retrieves the elevator car position by polling sensor 144 or pickup 115.

At step 1306, the microprocessor calculates the distance traveled, as previously described.

At step 1308, the microprocessor determines whether or not the distance traveled is less than the near terminal position. If not, the method moves to step 1310. If so, the method moves to step 1312.

At step 1310, the microprocessor resets the value V_{c} to the value of V_{near terminal}.

At step 1314, the microprocessor recalculates the S-curve with the new value of V_{c}. In a preferred embodiment the S-curve is calculated according to method 601.

At step 1316, the microprocessor sets the value of V to the difference between the near terminal velocity, V_{near terminal}, and Vₓ as determined in method 1200 according to the following equation.

$$V = {V}_{near terminal} - {V}_{x}$$

Where:
Vₓ=is the current velocity in memory, as calculated in real time, in method 1100.

At step 1318, the value of V is sent to the motor to set the motor speed.

At step 1320, the microprocessor determines whether or not the car is at the terminal position. If not, the method returns to step 1316. If so, the method moves to step 1322. In a preferred embodiment, when the elevator car is at a terminal, the microprocessor receives a near terminal indication from sensor 144 or pickup 115 indicating that the elevator car is at a terminal position.

At step 1312, the microprocessor determines whether or not a motion command change has been received from keypad 207. If not, the method returns to step 1304. If so, the method moves to step 1322.

At step 1322, the microprocessor determines a speed reduction value, Vᵣ, according to the following equation.

$${V}_{r} = D \times {T}_{s}$$

Where:
D=deceleration; and
Tₛ=present short deceleration time stored in memory.

At step 1324, the microprocessor calculates a new speed Vₙₛ according to the following equation.

$${V}_{new speed} = {V}_{c} - {V}_{r}$$

Where:
Vᵣ=V_{speed reduction}; and
V_{c}=contract speed.

At step 1326, the microprocessor sends the value of Vₙₛ to the motor to set the motor speed.

At step 1328, the microprocessor sends a stop-motion to the motor when the car reaches the terminal position, as previously described, or when speed is reduced to zero.

1. A control system for a traction elevator, the traction elevator including a car movably disposed in an elevator shaft, the car suspended by a hoist rope, the hoist rope motivated by a motor, the traction elevator further including a motion sensor reporting a car position in the elevator shaft, the control system comprising:
a processor, including a memory and a timer;
a motor controller, operatively connected to the motor and the processor;
a control panel, operatively connected to the processor; and
the memory containing a set of instructions, that when executed, cause the control system to:
receive a destination command identifying a destination position from the control panel;
choose a motion profile from a set of motion profiles;
the set of motion profiles including a normal profile, a short distance profile, and emergency power profile and an inspection profile;
determine an S-curve based on the motion profile;
determine a cruise start position, a deceleration start position and a leveling start position based on the S-curve;
monitor the car position to determine whether or not the car is at the cruise start position;
until the car reaches the cruise start position, monitoring an elapsed trip time timer to determine if the car is in a first acceleration phase, a second acceleration phase or a third acceleration phase;
sending a first signal to the motor if the car is in the first acceleration phase, a second signal to the motor if the car is in the second acceleration phase and a third signal to the motor if the car is in the third acceleration phase;
monitor the car position to determine whether or not the car is at the deceleration start position;
until the car reaches the deceleration start position, monitoring the elapsed trip time timer to determine if the car is in a cruising phase;
sending a fourth signal to the motor if the car is in the cruising phase;
monitor the car position to determine whether or not the car is at the leveling start position;
until the car reaches the leveling start position, monitoring the elapsed trip time timer to determine if the car is in a first deceleration phase, a second deceleration phase or a third deceleration phase;
sending a fifth signal to the motor if the car is in the first deceleration phase, a sixth signal to the motor if the car is in the second deceleration phase and a seventh signal to the motor if the car is in the third deceleration phase;
monitor the car position to determine whether or not the car is at the destination position;
until the car reaches the destination position, send an eighth signal to the motor if the car is in a leveling phase; and
send a stop signal to the motor when the car reaches the destination position.

2. The control system of claim 1, wherein the motion profile further comprises:
a set of time inflection points, a set of velocity inflection points and a set of position inflection points.

3. The control system of claim 2, wherein:
a start velocity and a first velocity inflection point, of the set of velocity inflection points, define the first acceleration phase;
the first velocity inflection point, of the set of velocity inflection points, and a second velocity inflection point, of the set of velocity inflection points, define the second acceleration phase;
the second velocity inflection point, of the set of velocity inflection points, and a third velocity inflection point, of the set of velocity inflection points, define the third acceleration phase;
the third velocity inflection point, of the set of velocity inflection points, and a fourth velocity inflection point, of the set of velocity inflection points, define the cruising phase;
the fourth velocity inflection point, of the set of velocity inflection points, and a fifth velocity inflection point, of the set of velocity inflection points, define the first deceleration phase;
the fifth velocity inflection point, of the set of velocity inflection points, and a sixth velocity inflection point, of the set of velocity inflection points, define the second deceleration phase; and
the sixth velocity inflection point, of the set of velocity inflection points, and a seventh velocity inflection point, of the set of velocity inflection points, define the third deceleration phase.

4. The control system of claim 1, wherein:
the normal profile includes a first set of parameters;
the short distance profile includes a second set of parameters, different from the first set of parameters;
the emergency power profile includes a third set of parameters, different from the first set of parameters and the second set of parameters; and
the inspection profile includes a fourth set of parameters different from the first set of parameters, the second set of parameters and the third set of parameters.

5. The control system of claim 4, wherein the first set of parameters further comprises:
Jᵢₐ (Jerk-In Acceleration)=2 f/s\hat{ }3;
J₀ₐ (Jerk-Out Acceleration)=2 f/s\hat{ }3;
A (Acceleration)=2 f/s\hat{ }2;
V_{c} (Contract Speed)=300 fpm;
J_{id} (Jerk-In Deceleration)=2 f/s\hat{ }3;
J_{od} (Jerk-Out Deceleration)=0.8 f/s\hat{ }3;
D (Deceleration)=1 f/s\hat{ }2;
D_{L} (Leveling Distance)=1 in;
Vᵢ (Leveling Speed)=10 fpm.

6. The control system of claim 4, wherein the second set of parameters further comprises:
Jᵢₐ (Jerk-In Acceleration)=2 f/s\hat{ }3;
J₀ₐ (Jerk-Out Acceleration)=4 f/s\hat{ }3;
A (Acceleration)=3 f/s\hat{ }2;
V_{c} (Contract Speed)=300 fpm;
J_{id} (Jerk-In Deceleration)=2 f/s\hat{ }3;
J_{od} (Jerk-Out Deceleration)=4 f/s\hat{ }3;
D (Deceleration)=3 f/s\hat{ }2;
D_{L} (Leveling Distance)=1 in;
Vᵢ (Leveling Speed)=10 fpm.

7. The control system of claim 4, wherein the third set of parameters further comprises:
Jᵢₐ (Jerk-In Acceleration)=1.8 f/s\hat{ }3;
J₀ₐ (Jerk-Out Acceleration)=1.8 f/s\hat{ }3;
A (Acceleration)=1.5 f/s\hat{ }2;
E-power Speed=100 fpm;
J_{id} (Jerk-In Deceleration)=1.8 f/s\hat{ }3;
J_{od} (Jerk-Out Deceleration)=1.8 f/s\hat{ }3;
D (Deceleration)=1.5 f/s\hat{ }2;
D_{L} (Leveling Distance)=1 in;
Vᵢ (Leveling Speed)=10 fpm.

8. The control system of claim 4, wherein the fourth set of parameters further comprises:
Jᵢₐ (Jerk-In Acceleration)=1.5 f/s\hat{ }3;
J₀ₐ (Jerk-Out Acceleration)=1.5 f/s\hat{ }3;
A (Acceleration)=1 f/s\hat{ }2;
V_{c} (Contract Speed)=300 fpm;
J_{id} (Jerk-In Deceleration)=2 f/s\hat{ }3;
J_{od} (Jerk-Out Deceleration)=0.8 f/s\hat{ }3;
D (Deceleration)=1 f/s\hat{ }2;
D_{L} (Leveling Distance)=1 in;
Vᵢ (Leveling Speed)=10 fpm;
Inspection Speed=50 fpm.

9. The control system of claim 1, wherein the step of determining the S-curve further comprises:
determining a maximum possible speed for the car.

10. The control system of claim 1, wherein the set of instructions further comprises instructions that when executed, cause the control system to:
during one of the first acceleration phase, the second acceleration phase and the third acceleration phase, determine whether or not there has been a midflight destination change; and
generate a revised S-curve based on the midflight destination change.

11. A method for controlling a traction elevator, the traction elevator including a car movably disposed in an elevator shaft, the car suspended by a hoist rope, the hoist rope motivated by a motor, the traction elevator further including a motion sensor reporting a car position in the elevator shaft, the method comprising:
providing a processor, including a memory and a timer;
providing a motor controller, operatively connected to the motor and the processor;
providing a control panel, operatively connected to the processor; and
providing the memory with a set of instructions, that when executed, cause the method to:
receive a destination command identifying a destination position from the control panel;
choose a motion profile from a set of motion profiles;
the set of motion profiles including a normal profile, a short distance profile, and emergency power profile and an inspection profile;
determine an S-curve based on the motion profile;
determine a cruise start position, a deceleration start position and a leveling start position based on the S-curve;
monitor the car position to determine whether or not the car is at the cruise start position;
until the car reaches the cruise start position, monitoring an elapsed trip time timer to determine if the car is in a first acceleration phase, a second acceleration phase or a third acceleration phase;
sending a first signal to the motor if the car is in the first acceleration phase, a second signal to the motor if the car is in the second acceleration phase and a third signal to the motor if the car is in the third acceleration phase;
monitor the car position to determine whether or not the car is at the deceleration start position;
until the car reaches the deceleration start position, monitoring the elapsed trip time timer to determine if the car is in a cruising phase;
sending a fourth signal to the motor if the car is in the cruising phase;
monitor the car position to determine whether or not the car is at the leveling start position;
until the car reaches the leveling start position, monitoring the elapsed trip time timer to determine if the car is in a first deceleration phase, a second deceleration phase or a third deceleration phase;
sending a fifth signal to the motor if the car is in the first deceleration phase, a sixth signal to the motor if the car is in the second deceleration phase and a seventh signal to the motor if the car is in the third deceleration phase;
monitor the car position to determine whether or not the car is at the destination position;
until the car reaches the destination position, send an eighth signal to the motor if the car is in a leveling phase; and
send a stop signal to the motor when the car reaches the destination position.

12. The method of claim 11, wherein the step of choosing the motion profile further comprises:
choosing a set of time inflection points, a set of velocity inflection points and a set of position inflection points.

13. The method of claim 12, wherein the step of choosing the set of time inflection points, the set of velocity inflection points and the set of position inflection points further comprises:
choosing a start velocity and a first velocity inflection point, of the set of velocity inflection points, that define the first acceleration phase;
choosing the first velocity inflection point, of the set of velocity inflection points, and a second velocity inflection point, of the set of velocity inflection points, that define the second acceleration phase;
choosing the second velocity inflection point, of the set of velocity inflection points, and a third velocity inflection point, of the set of velocity inflection points, that define the third acceleration phase;
choosing the third velocity inflection point, of the set of velocity inflection points, and a fourth velocity inflection point, of the set of velocity inflection points, that define the cruising phase;
choosing the fourth velocity inflection point, of the set of velocity inflection points, and a fifth velocity inflection point, of the set of velocity inflection points, that define the first deceleration phase;
choosing the fifth velocity inflection point, of the set of velocity inflection points, and a sixth velocity inflection point, of the set of velocity inflection points, that define the second deceleration phase; and
choosing the sixth velocity inflection point, of the set of velocity inflection points, and a seventh velocity inflection point, of the set of velocity inflection points, that define the third deceleration phase.

14. The method of claim 11, further comprising the steps of:
providing the normal profile with a first set of parameters;
providing the short distance profile with a second set of parameters, different from the first set of parameters;
providing the emergency power profile with a third set of parameters, different from the first set of parameters and the second set of parameters; and
providing the inspection profile with a fourth set of parameters different from the first set of parameters, the second set of parameters and the third set of parameters.

15. The method of claim 14, further comprising the step of providing the first set of parameters as:
Jᵢₐ (Jerk-In Acceleration)=2 f/s\hat{ }3;
J₀ₐ (Jerk-Out Acceleration)=2 f/s\hat{ }3;
A (Acceleration)=2 f/s\hat{ }2;
V_{c} (Contract Speed)=300 fpm;
J_{id} (Jerk-In Deceleration)=2 f/s\hat{ }3;
J_{od} (Jerk-Out Deceleration)=0.8 f/s\hat{ }3;
D (Deceleration)=1 f/s\hat{ }2;
D_{L} (Leveling Distance)=1 in;
Vᵢ (Leveling Speed)=10 fpm.

16. The method of claim 14, further comprising the step of providing the second set of parameters as:
Jᵢₐ (Jerk-In Acceleration)=2 f/s\hat{ }3;
J₀ₐ (Jerk-Out Acceleration)=4 f/s\hat{ }3;
A (Acceleration)=3 f/s\hat{ }2;
V_{c} (Contract Speed)=300 fpm;
J_{id} (Jerk-In Deceleration)=2 f/s\hat{ }3;
J_{od} (Jerk-Out Deceleration)=4 f/s\hat{ }3;
D (Deceleration)=3 f/s\hat{ }2;
D_{L} (Leveling Distance)=1 in;
Vᵢ (Leveling Speed)=10 fpm.

17. The method of claim 14, further comprising the step of providing the third set of parameters as:
Jᵢₐ (Jerk-In Acceleration)=1.8 f/s\hat{ }3;
J₀ₐ (Jerk-Out Acceleration)=1.8 f/s\hat{ }3;
A (Acceleration)=1.5 f/s\hat{ }2;
E-power Speed=100 fpm;
J_{id} (Jerk-In Deceleration)=1.8 f/s\hat{ }3;
J_{od} (Jerk-Out Deceleration)=1.8 f/s\hat{ }3;
D (Deceleration)=1.5 f/s\hat{ }2;
D_{L} (Leveling Distance)=1 in;
Vᵢ (Leveling Speed)=10 fpm.

18. The method of claim 14, further comprising the step of providing the fourth set of parameters as:
Jᵢₐ (Jerk-In Acceleration)=1.5 f/s\hat{ }3;
J₀ₐ (Jerk-Out Acceleration)=1.5 f/s\hat{ }3;
A (Acceleration)=1 f/s\hat{ }2;
V_{c} (Contract Speed)=300 fpm;
J_{id} (Jerk-In Deceleration)=2 f/s\hat{ }3;
J_{od} (Jerk-Out Deceleration)=0.8 f/s\hat{ }3;
D (Deceleration)=1 f/s\hat{ }2;
D_{L} (Leveling Distance)=1 in;
Vᵢ (Leveling Speed)=10 fpm;
Inspection Speed=50 fpm.

19. The method of claim 11, wherein the step of determining the S-curve further comprises:
determining a maximum possible speed for the car.

20. The method of claim 11, wherein the step of providing the memory with the set of instructions further comprises providing instructions that when executed, cause the method to:
during one of the first acceleration phase, the second acceleration phase and the third acceleration phase, determine whether or not there has been a midflight destination change; and
generate a revised S-curve based on the midflight destination change.
